(19) United States
(12) Patent Application Publication
(10) Pub. No.: US 2024/0025694 A1
(43) Pub. Date: Jan. 25, 2024

(54) A Method and a Machinery for Making an Informational Item.

(71) Applicants: Sanjay Madhav DANDEKAR, PUNE (IN); Datta Hari DESHPANDE, Pune (IN)

(72) Inventors: Sanjay Madhav DANDEKAR, PUNE (IN); Datta Hari DESHPANDE, Pune (IN)

(21) Appl. No.: 18/031,210

(22) PCT Filed: Oct. 12, 2020
(86) PCT No.: PCT/IB2020/059553

§ 371 Date: Apr. 11, 2023

(51) Int. Cl. B65H 45/18

(52) U.S. Cl. CPC B65H 45/18; B65H 2301/5142; B65H 2301/45; B65H 2301/5113; B65H 2301/5111

(57) ABSTRACT

The present invention provides methods (100a or 100b or 100c) and machinery (200a, 200b & 200c) for making informational items (550a, 550b & 540c). The methods comprise steps of feeding a sheet (480a, 480b 480c) to a first folding machine (210a, 210b, 210c) for obtaining a strip (500a, 500b 500c).The strip is virtually divided into equal segments by marking fold lines thereon. A first cross folds on the strip using a second folding machine for obtaining a first folded strip (510a or 510b) having a first folded segment (512a or 512b) and a second folded segment (514a or 514b) with equal or unequal predefined lengths. A plurality of cross folds is performed on the first folded strip for making the final informational item. The methods and the machinery decrease the value of the ratio of the layer thickness (tₛ), thereby increases the easiness of folding operations.

### FIELD OF THE INVENTION

The present invention relates to a method and a machinery for making an informational item. More specifically, the present invention relates to a method and a machinery for making pharmaceutical outserts and inserts.

### BACKGROUND OF THE INVENTION

Generally, a package of medicines includes one or more informational items therein. These informational items include information of the medications printed thereon according to related laws in a specific country. Pharmaceutical inserts & outserts are some examples of these informational items. The informational item may be attached to a pharmaceutical container or maybe inserted loosely in a cardboard box in which pharmaceutical container is kept. The informational item can be unfolded by a consumer to read the information printed thereon.

Existing methods of making an informational item (outsert or insert) uses a plurality of folding machines to perform a plurality of cross folds on a sheet to obtain a final informational item. Presently, there are different types of folding machines. Some of the folding machines are a roller folding machine and a knife folding machine. The roller folding machine includes a plurality of rollers to perform cross folds thereon the fed sheet. An article needs to be folded introduced between the rollers; the rollers are rotated according to fold and move the received article to a predefined destination. The knife folding machines also includes a pair of rollers and a knife. An article needs to be folded moved on the rollers, and the knife operated and moved on a fold line. The knife presses the article for making a fold in the article. Further, the rollers are rotated to move the folded article to a predefined destination.

U.S. Pat. No. 7,896,796B2 describes Methods of forming outserts and outserts formed thereby. The method described in the U.S. Pat. No. 7,896,796B2 comprises steps of performing a plurality of folds on a sheet for obtaining an informational item. Referring now to figures P1a1, P2a, P3a, P4a, P5a showing tops views of intermediate folded items (410, 420, 430, 440, 450); P1a2 showing a bottom view of an intermediate item 410; P1b, P2b, P3b, P4b, P5b showing side views of the intermediate folded items 410, 420, 430, 440, 450 obtained at the end of the steps carried out in the method described in U.S. Pat. No. 7,896,796B2.

A paper is fed to a folding machine to perform a plurality of folds to obtain the intermediate item (410). The intermediate item (410) is having multiple layers having a total layer thickness (t). The layer thickness (t) here refers to a parallel distance between a topmost surface (410a) and a bottommost surface (410b) of the intermediate item (410). A cross fold is made along a fold line (452) on the intermediate item 450 to making a final outsert (not shown). The fold line (452) divides the intermediate item 450 into a head portion (450a) and a tail portion (450b). More specifically, a normal fold line plane (452p) divides the intermediate item 450 into the head portion (450a) and the tail portion (450b). The accumulated layer thickness of the head portion (450a), which is in contact with the normal fold line plane (452p) is 12(t), and the accumulated layer thickness of the tail portion (450b), which is in contact with the normal fold line plane (452p) is 2(t).

A ratio of the accumulated layer thickness of the head portion (450a) and the accumulated layer thickness of the tail portion (450b) can be called as a layer thickness ratio (tₛ). The experimental studies are conducted to find the impact the layer thickness ratio (tₛ) on the easiness of performing a folding operation using folding units. The inference of the experimental studies is that, the lower value of the layer thickness ratio (tₛ), easier the folding operation. The value of the layer thickness ratio (tₛ) of the intermediate item (450) made using the method described by the U.S. Pat. No. 7,896,796B2 is 6.

Therefore, there is a need for a method and machinery for making an informational item, with the decreased value of the layer thickness ratio (tₛ) compared to the method described by the U.S. Pat. No. 7,896,796B2 which overcomes from the problems of the prior art.

### OBJECTS OF THE INVENTION

An object of the present invention is to provide methods and machinery for making informational items.

Another object of the present invention is to provide methods and machinery for making informational items, and the methods are capable of making an informational item with a lesser value of the layer thickness ratio (tₛ) compared to existing methods of making an informational item, thereby increasing easiness for performing a folding operation using folding units.

### SUMMARY OF THE INVENTION

According to the present invention, there is provided with a method and a machinery for making an informational item. The informational item is having product information printed thereon. The informational item is an outsert or an insert. The method comprising steps of feeding a sheet into a first folding machine. The sheet is made from paper or plastic. The first folding machine is a roller folding machine. In an alternative embodiment, the first folding machine is a knife folding machine. The first folding machine is adapted to receive a sheet thereto. The first folding machine is making at least two parallel folds on the sheet for making a strip. The strip is divided into predefined equal segments by marking fold lines thereon.

Further, the first folding machine includes a fold line marking unit for marking at least one virtual mark or groove along predefined fold lines on the strip. The first folding machine is adapted to virtually divide the strip into equal segments. The length of each segment is equal to a length (L) of the informational item; The at least one virtual mark or groove divides the strip into a first folded segment and a second folded segment, wherein the length of the first folded segment is equal or more than or less than the second folded segment.

The fold line marking unit includes mechanical elements such as rollers, sprinklers or markers and the like arranged accordingly to marking the at least one virtual mark or groove for dividing the strip into the first folded segment and a second folded segment. The sprinklers are arranged accordingly to sprinkle water along the at least one virtual mark on the sheet before feeding to the rollers of the first folding machine and rollers are arranged accordingly to make the groove along at least one mark on the strip.

A first cross fold is made on the strip along at least one virtual mark or the groove using a second folding machine for obtaining a first folded strip. The second folding machine is adapted to receive the strip thereto. The second folding machine is a roller folding machine. In an alternative embodiment, the second folding machine is a knife folding machine. The first folded strip is having a first folded segment and a second folded segment. The length of the first folded segment is equal, more than or less than to the length of the second folded segment The length of the first folded segment or the second folded segment are having predefined lengths. The predefined length of the first folded segment or/and the second folded segment is equal to decimal multiples of the equal segment.

A second cross fold is made on the first folded strip using a third folding machine for obtaining a second folded strip. In an embodiment, the second folding machine and the third folding machine are integrally mounted in a housing). The third folding machine is adapted to receive the first folded strip. The third folding machine is a roller folding machine. In an alternative embodiment, the third folding machine is a knife folding machine. The second folded strip is having a third folded segment and a fourth folded segment. The length of the third folded segment or the fourth folded segment are having predefined lengths. The predefined lengths of the third folded segment and/or the fourth folded segment is equal to decimal multiples of the equal segments.

A third cross fold is made on the second folded strip using a fourth folding machine for obtaining a third folded strip. The fourth folding machine is adapted to receive the second folded strip thereto. The fourth folding machine is a roller folding machine. In an alternative embodiment, the fourth folding machine is a knife folding machine. The third folded strip is having a fifth folded segment and a sixth folded segment. The third folded strip is pressed by a first pressing unit before feeding to the fifth folding machine.

A fourth cross fold is made on the third folded strip using a fifth folding machine for obtaining a fourth folded strip. The fifth folding machine is adapted to receive the third folded strip thereto. The fifth folding machine is a roller folding machine. In an alternative embodiment, the fifth folding machine is a knife folding machine. The fourth folded strip is pressed by a second pressing unit before feeding to the sixth folding machine. The fourth folded strip is having a seventh folded segment and an eighth folded segment.

A fifth cross fold is made on the fourth folded strip using a sixth folding machine for obtaining the informational item. The sixth folding machine is adapted to receive the fourth folded strip. The sixth folding machine is a roller folding machine. In an alternative embodiment, the sixth folding machine is a roller folding machine. The informational item is having a ninth folded segment and a tenth folded segment. The informational item is pressed by a third pressing unit before moving the informational item to a predefined destination.

The ninth folded segment and the tenth folded segment are binds by a binding agent applied accordingly thereon. The binding agent is an adhesive. The machinery includes an adhesive application unit. The adhesive application unit is operated to apply the binding agent on the ninth folded segment, and the tenth folded segment. The binding agent applied ninth folded segment, and the tenth folded segment is pressed accordingly for binding there together. In an alternative embodiment, the ninth folded segment and the tenth folded segment are binds by a binding member. Alternately, the binding member is a clip or adhesive tape.

The machinery includes a conveyor system. The conveyor system is operated to transfer the sheet to the first folding machine, and transfer the strip to the second folding machine, transfer the first folded strip to the third folding machine, transfer the second folded strip to the fourth folding machine, transfer the third folded strip to the fifth folding machine, transfer the fourth folded strip to the sixth folding machine and transfer the informational item to a predefined destination.

In an alternative embodiment, the conveyor system is operated to transfer the third folded strip from the first pressing unit to the fifth folding machine and transfer the informational item from the second pressing unit to a predefined destination.

The conveyor system includes a conveyor path having at least one segment. The segments of the conveyor path) is (are) arranged according to the available space for arranging (set up) the machinery to configure the conveyor path. The shape of the conveyor path is “L”, “U”, “Z”&“C”. The conveyor system is a belt conveyor system or a chain conveyor system or air conveyor system.

The present invention also provides an alternative embodiment of a method and a machinery for making an informational item. The method comprising steps of feeding a sheet into a first folding machine. The sheet is made from paper or plastic. The first folding machine is a roller folding machine. In an alternative embodiment, the first folding machine is a knife folding machine. The first folding machine adapted to receive the sheet thereto. The first folding machine is making at least two parallel folds on the sheet for making a strip. The strip is virtually divided into the equal segment.

Further, the first folding machine (includes a fold line marking unit for marking at least one virtual mark or groove along fold lines on the strip. The at least one virtual mark or groove or water scoring divides the strip into segments where it is folded in subsequent processes like a first folded segment and a second folded segment, wherein the length of the first folded segment is more than or less than the second folded segment. The first folding machine virtually divides the strip into equal segments.

The fold line marking unit for marking at least one virtual mark or on the strip, the fold line marking unit includes mechanical elements such as rollers, sprinklers or markers and the like arranged accordingly to mark the at least one virtual mark or groove for dividing the strip into the first folded segment and the second folded segment. The length of the first folded segment is more than the length of the second folded segment. The sprinklers are arranged accordingly to sprinkle water along the at least one virtual mark on the sheet before feeding to the rollers of the first folding machine and rollers are arranged accordingly to make the groove along at least one mark on the strip.

The first cross fold is made on the strip using a second folding machine along the at least virtual mark or groove for obtaining a first folded strip. The second folding machine is a roller folding machine. In an alternative embodiment, the second folding machine is a knife folding machine. The second folding machine is adapted to receive the strip thereto. The first folded strip is having the first folded segment and the second folded segment. The length of the first folded segment is unequal to the length of the second folded segment, the first folded segment and the second folded segment are having predefined lengths. The predefined length of the first folded segment or/and the second folded segment is equal to decimal multiples of the segment.

A second cross fold is made on the first folded strip using a third folding machine for obtaining a second folded strip. The third folding machine is a roller folding machine. In an alternative embodiment, the third folding machine is a knife folding machine. The second folding machine and the third folding machine is integrally mounted in a housing. The third folding machine is adapted to receive the first folded strip thereto. The second folded strip is having a fourth folded segment. The third folded segment and the fourth folded segment are having predefined lengths. Either the length of the third folded segment or/and the fourth folded segment is equal to the decimal multiples of the segment (L).

A third cross fold is made on the second folded strip using a fourth folding machine for obtaining a third folded strip. The fourth folding machine is a roller folding machine. In an alternative embodiment, the fourth folding machine is a knife folding machine. The fourth folding machine is adapted to receive the second folded strip thereto. The third folded strip is having a fifth folded segment and a sixth folded segment. The third folded strip is pressed by a first pressing unit before feeding to the fifth folding machine.

The fourth cross fold is made on the third folded strip using a fifth folding machine for obtaining the informational item. The fifth folding machine is a roller folding machine. In an alternative embodiment, the fifth folding machine is a knife folding machine. The fifth folding machine adapted to receive the third folded strip thereto. The informational item is having a seventh folded segment and an eighth folded segment. The seventh folded segment and the eighth folded segment are bound by a binding agent applied accordingly thereon. The binding agent is an adhesive.

The machinery includes an adhesive application unit. The adhesive application unit is operated to apply a binding agent on the seventh folded segment and the eighth folded segment. The seventh folded segment and the eighth folded segment are binds by a binding member. The binding member is a clip or adhesive tape. The binding agent applied seventh folded segment, and the eighth folded segment is pressed accordingly for binding there together. The informational item is pressed by a second pressing unit before moving the informational item to a predefined destination. The knife folding machine includes a knife. The knife is operated to perform a folding operation.

The machinery includes a conveyor system. The conveyor system is operated to transfer the sheet to the first folding machine, and transfer the strip (500c) to the second folding machine, transfer the first folded strip to the third folding machine, transfer the second folded strip to the fourth folding machine, transfer the third folded strip to the fifth folding machine and transfer the informational item to the predefined destination. In an alternative embodiment, the conveyor system is operated to transfer the third folded strip from the first pressing unit to the fifth folding machine and transfer the informational item from the second pressing unit to the predefined destination.

The conveyor system includes a conveyor path having at least one segment. The segments of the conveyor path are arranged according to the available space for arranging (set up) the machinery to configure the conveyor path. The shape of the conveyor path is “L”, “U”, “Z” and “C”. The conveyor system is a belt or roller conveyor system or a chain conveyor system or air conveyor system.

### BRIEF DESCRIPTION OF THE DRAWINGS

The advantages and features of the present invention will be understood better with reference to the following detailed description of some embodiments of the and claims taken in conjunction with the accompanying drawings, wherein like elements are identified with like symbols, and in which;

Figures P1a, P2a, P3a, P4a, P5a show top views of various intermediate items obtained in making an informational item using a known method (prior art);

Figure P1a2 shows a bottom view of an intermediate item shown in figure P1a;

Figures P1b, P2b, P3b, P4b, P5b show side views of various intermediate items obtained in making an informational item using a known method (prior art);

FIG. 1 shows a flow chart of operations carried out in a method for making an informational item in accordance with the present invention;

FIGS. 2, 2a, 2b, 2c, 2d, 2e, 2f, 5, 5a, 5b, 5c, 5c1, 5d, 5d1, 5e, 5e1, 5f, 5f1, 8, 8a, 8b, 8c, 8d, 8e show top views various intermediate items obtained while making an informational item by the method shown in FIG. 1;

FIGS. 2a″, 2b″, 2c″, 2d″, 2e″, 2f′, 5a″, 5b″, 5c″, 5c1″, 5d″, 5e″, 5e1″, 5f′, 5f1″, 8a″, 8b″, 8c″, 8d″, 8e″ show side views FIGS. 2a, 2b, 2c, 2d, 2e, 2f, 5, 5a, 5b, 5c, 5c1, 5d, 5d1, 5e,5e1,5f, 5f1, 8,8a, 8b,8c,8d,8e respectively;

FIG. 3, FIG. 6, FIG. 9 show schematic block diagrams of various embodiments of machinery for making an informational item in accordance with the present invention;

FIGS. 3a, 3b, 3c, 3d, 3e, 3f, 6a, 6b, 6c, 6d,6e, 6f, 9a, 9b, 9c, 9d, 9e, 9f show schematic block diagrams of various embodiments of a conveyor system of the machinery shown in FIG. 3, FIG. 6, FIG. 9 respectively;

FIG. 4 shows a flow chart of operations carried out in an alternative embodiment of a method for making an informational item in accordance with the present invention; and

FIG. 7 shows a flow chart of operations carried out in an alternative embodiment of a method for making an informational item in accordance with the present invention;

### DETAILED DESCRIPTION OF THE INVENTION

An embodiment of this invention, illustrating its features, will now be described in detail. The words “comprising”, “having”, “containing,” and “including,” and other forms thereof, are intended to be equivalent in meaning and be open-ended in that an item or items following any one of these words is not meant to be an exhaustive listing of such item or items or meant to be limited to only the listed item or items.

The terms “first,” “second,” and the like, herein do not denote any order, quantity, or importance, but rather are used to distinguish one element from another, and the terms “an” and “a” herein do not denote a limitation of quantity, but rather denote the presence of at least one of the referenced item.

The disclosed embodiments are merely exemplary of the invention, which may be embodied in various forms.

The present invention provides methods and machinery for making an informational item. The methods easies operation of folding while making the informational item.

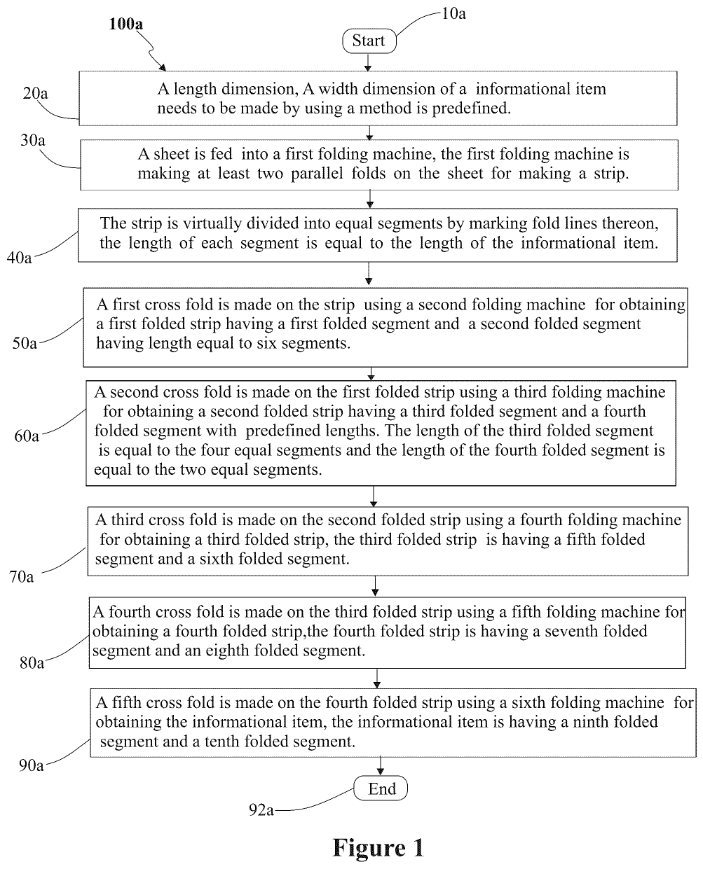

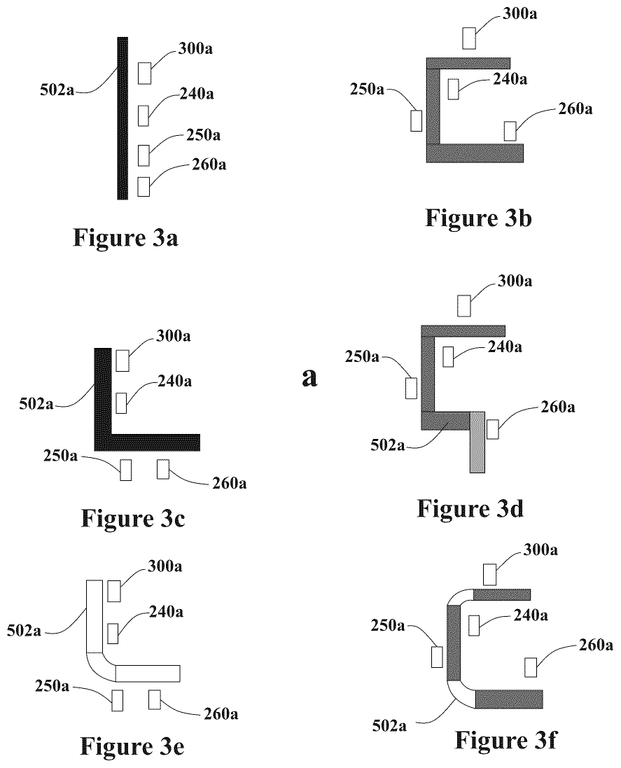

Referring now to FIG. 1, showing a flow chart of operations being carried out in a method for making an informational item in accordance with the present invention. Hereinafter the method is referred to as the method (100a), and the informational item is referred to as the informational item (550a). The present invention also provides a machinery (200a) (refer FIG. 3) for making the informational item (550a). For the brevity of the invention, the method (100a) is explained along with the machinery (200a) used for carryout the operations of the method (100a). The informational item (550a) is having the product information printed thereon. The informational item (550a) is an outsert or an insert.

The method (100a) starts at step 10a.

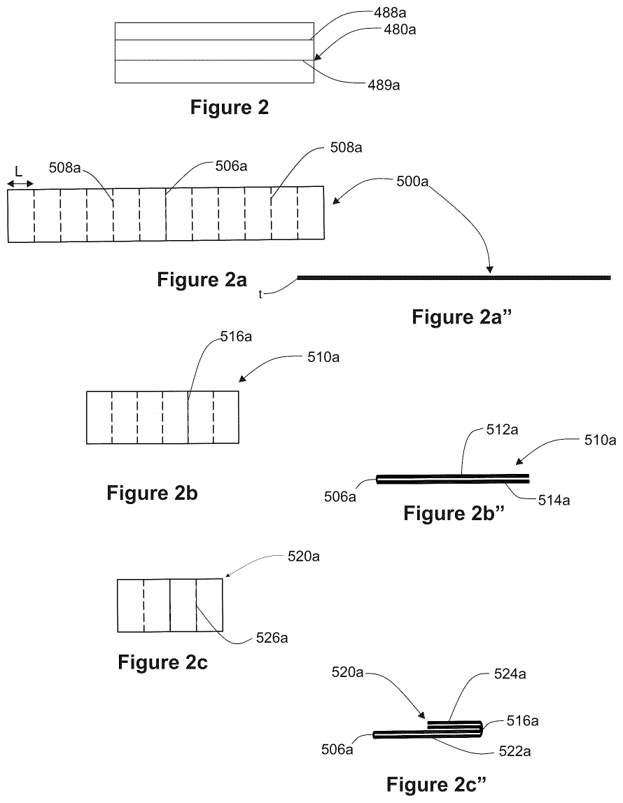

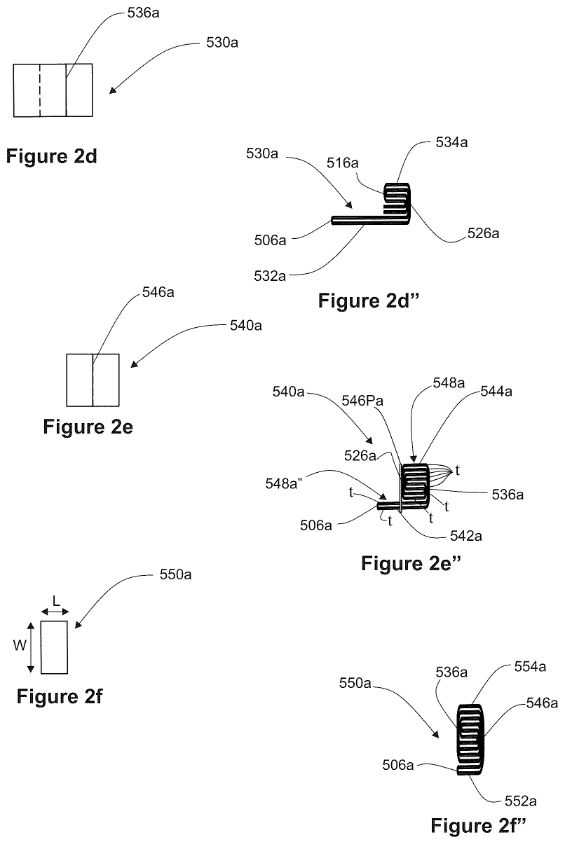

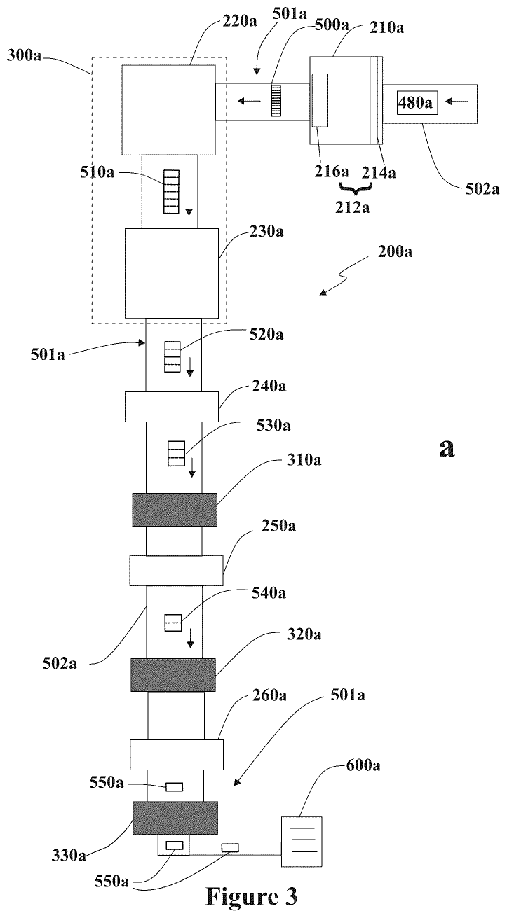

At step 20a, a length dimension, a width dimension of an expected final informational item (550a) (refer FIGS. 2f and 2f″) needs to be made by using the method (100a) is predefined. Say the length of the final informational item (550a) is “L” and the width of the final informational item is “W”.

At step 30a, a sheet of paper 480 (refer FIG. 2) is fed into a first folding machine (210a) (refer FIG. 3). The sheet (480a) is made from paper or plastic. The first folding machine (210a) is a roller folding machine. In an alternative embodiment, the first folding machine (210a) is a knife folding machine. The first folding machine (210a) is adapted to receive the sheet (480a) thereto. The first folding machine (210a) is making at least two parallel folds on the sheet (480a) for making a strip (500a) (refer FIGS. 2a and 2a′). In the present embodiment, the parallel folds are made along a length direction of the sheet (480a). In an alternative embodiment, the parallel folds are made along a width direction of the sheet (480a).

More specially, the parallel folds are made along fold lines (488a, 489a). The parallel folds make the sheet (480a) into the strip (500a) with a zigzag pattern folded layers. It may be obvious to a person skilled in the art to convert the strip (500a) by feeding the sheet (480a) into the first folding machine (210a) and operating the first folding machine (210a) for making the strip (500a) accordingly.

At step 40a, the strip (500a) is virtually divided into equal segments (L) by marking fold lines (508a) thereon. “Virtually dividing” here refers to the strip (500a) is divided into the equal segments (l) without actually folding on the fold lines (508a). The purpose of the virtually dividing the strip (500a) is to obtain intermediate items (510a, 520a, 530a, 540a) and the informational item (550a) by making a plurality of cross folds accordingly, the intermediate items (510a, 520a, 530a, 540a) and the informational item (550a) are having lengths in terms of segments, which is defined in terms of the geometric dimensions (length and width) of the informational item (550a) obtained by the method (100a). In the present embodiment, the total length of the strip (500a) is virtually divided into twelve equal segments (L). In an alternative embodiment, the total length of the strip (500a) is divided into any obvious mathematical segments (L) which is defined based on various factors such as a total surface area of the sheet (480a), a length of the strip (500a) and other requirements. A length of each segment (L) is equal to a length (L) of the informational item (550a). The first folding machine (210a) is adapted to virtually divide the strip (500a) into equal segments by marking fold lines thereon;

Further, the first folding machine (210a) includes a fold line marking unit (212a) for marking at least one virtual mark or a groove along a fold line (506a) on the strip (500a). The fold line marking unit (212a) includes mechanical elements such as rollers (216a), sprinklers (214a) or markers and the like arranged accordingly to mark the at least one virtual mark or groove for dividing the strip (500a) into a first folded segment (512a) and a second folded segment (514a).

In the machinery (200a), the fold line marking unit (212a) is adapted to mark at least one virtual mark or groove on the strip (500a). The sprinklers (214a) are arranged accordingly to sprinkle water along the at least one virtual mark on the sheet (480a) before feeding to the rollers of the first folding machine (210a), and the rollers (216a) are arranged accordingly to make the groove along at least one mark on the strip (500a).

At step 50a, a first cross fold is made on the strip (500a) using a second folding machine (220a) (refer FIG. 3) for obtaining a first folded strip (510a) (refer FIGS. 2b and 2b″). The second folding machine (220a) is adapted to receive the strip (500a) thereto. The second folding machine (220a) is a roller folding machine. In an alternative embodiment, the second folding machine (220a) is a knife folding machine. More specifically, the second folding machine (220a) is operated to cross fold the strip (500a) along the fold line (506a) (refer FIG. 2a″) for making the first folded strip (510a). The first folded strip (510a) is having the first folded segment (512a) and the second folded segment (514a). The first folded segment (512a) and the second folded segment (514a) are having predefined lengths. The length of the first folded segment (512a) is equal to the length of the second folded segment (514a).

In the shown example, the predefined length of the first folded segment (512a) is equal to the six equal segments (L) and the length of the second folded segment (514a) is equal to the six equal segments (L).

At step 60a, a second cross fold is made on the first folded strip (510a) using a third folding machine (230a) (refer FIG. 3) for obtaining a second folded strip (520a) (refer FIG. 2c). The third folding machine (230a) is adapted to receive the first folded strip (510a). The third folding machine (230a) is a roller folding machine. In an alternative embodiment, the third folding machine (230a) is a knife folding machine. In an embodiment, the second folding machine (220a) and the third folding machine (230a) are integrally mounted in a housing (300a).

More specifically, the third folding machine (230a) is operated to cross fold the first folded strip (510a) along a fold line (516a) (refer FIG. 2c″) for making the second folded strip (520a). The second folded strip (520a) is having a third folded segment (522a) and a fourth folded segment (524a). The third folded segment (522a) and the fourth folded segment (524a) are having predefined lengths. The predefined length of the third folded segment (522a) and the fourth folded segment (524a) is equal to a predefined length of equal whole segments. In this example, the length of the third folded segment (522a) is equal to the four equal segments (L), and the length of the fourth folded segment (524a) is equal to the two equal segments (L).

At step 70a, a third cross fold is made on the second folded strip (520a) using a fourth folding machine (240a) (refer FIG. 3) for obtaining a third folded strip (530a) (refer 2d and 2d″). The fourth folding machine (240a) is adapted to receive the second folded strip (520a) thereto. The fourth folding machine (240a) is a roller folding machine. In an alternative embodiment, the fourth folding machine (240a) is a knife folding machine.

More specifically, the fourth folding machine (240a) is operated to cross fold the second folded strip (520a) along a fold line (526a) (refer FIGS. 2c & 2d″) for making the third folded strip (530a). The third folded strip (530a) is having a fifth folded segment (532a) and a sixth folded segment (534a). The third folded strip (530a) is pressed by a first pressing unit (310a) before feeding to the fifth folding machine (250a). In this example, the length of the fifth folded segment (532a) is equal to the three equal segments (L), and the length of the sixth folded segment (534a) is equal to the one equal segment (L).

At step 80a, a fourth cross fold is made on the third folded strip (530a) using a fifth folding machine (250a) (refer FIG. 3) for obtaining a fourth folded strip (540a) (refer FIGS. 2e & 2e″). The fifth folding machine (250a) is adapted to receive the third folded strip (530a) thereto. The fifth folding machine (250a) is a roller folding machine. In an alternative embodiment, the fifth folding machine (250a) is a knife folding machine.

More specifically, the fifth folding machine (250a) is operated to cross fold the third folded strip (530a) along a fold line (536a) for making the fourth folded strip (540a). The fourth folded strip (540a) is having a seventh folded segment (542a) and an eighth folded segment (544a). The fourth folded strip (540a) is pressed by a second pressing unit (320a) before feeding to the sixth folding machine (260a). In this example, the length of the seventh folded segment (542a) is equal to the two equal segments (L). The length of the eighth folded segment (544a) is equal to the one equal segment (L).

At step 90a, the fifth cross fold is made on the fourth folded strip (540a) using a sixth folding machine (260a) (refer FIG. 3) for obtaining the informational item (550a) (FIGS. 2f and 2f′). The sixth folding machine (260a) is adapted to receive the fourth folded strip (540a). The sixth folding machine (260a) is a roller folding machine. In an alternative embodiment, the sixth folding machine (260a) is a knife folding machine.

More specifically, the sixth folding machine (260a) is operated to cross fold the fourth folded strip (540a) along a fold line (546a) for making the fifth folded strip (550a). The informational item (550a) is having a ninth folded segment (552a) and a tenth folded segment (554a). The informational item (550a) is pressed by a third pressing unit (330a) before moving the informational item (550a) to a predefined destination. In this example, the length of the ninth folded segment (552a) is equal to the one equal segment (L), and the length of the tenth folded segment (554a) is equal to the one equal segment (L). Fold lines of the first cross fold (506a), the second cross fold (516a), the third cross fold (526a), the fourth cross fold (536a) and the fifth cross fold (546a) are perpendicular to the length of the strip (500a).

The method (100a) ends at step 92a.

Further, the ninth folded segment (552a) and the tenth folded segment (554a) are binds by a binding agent (not shown) applied accordingly thereon. The binding agent is an adhesive. The machinery (200a) includes an adhesive application unit. The adhesive application unit is operated to apply the binding agent on the ninth folded segment (552a), and the tenth folded segment (554a). The binding agent applied ninth folded segment (552a), and the tenth folded segment (554a) are pressed accordingly for binding there together. In an alternative embodiment, the ninth folded segment (552a) and the tenth folded segment (554a) are binds by a binding member. The binding member is a clip or adhesive tape (not shown in the figure).

The machinery (100a) includes a conveyor system (501a). The conveyor system (501a) includes a conveyor path (502a) having at least one segment, the segments of the conveyor path (502a) is arranged according to the available space for arranging (set up) the machinery to configure the conveyor path. The shape of the conveyor path (502a) is “L”, “U”, “Z” or “C” and various shapes (refer as shown in FIGS. 3a, 3b, 3c, 3d, 3e and 3f). The conveyor system (501a) is a belt conveyor system or a chain conveyor system or air conveyor system.

The conveyor system (501a) is operated to transfer the sheet (480a) to the first folding machine (210a), and transfer the strip (500a) to the second folding machine (220a), transfer the first folded strip (510a) to the third folding machine (230a), transfer the second folded strip (520a) to the fourth folding machine (240a), transfer the third folded strip (530a) to the fifth folding machine (250a), transfer the fourth folded strip (540a) to the sixth folding machine (260a) and transfer the informational item (550a) to a predefined destination. The predefined destination can be a stacking unit (not shown). In an alternative embodiment of the conveyor system (501a), the conveyor system (501a) is operated to transfer the third folded strip (530a) from the first pressing unit (310a) to the fifth folding machine (250a), transfer the fourth folded strip (540a) from the second pressing unit (320a) to the sixth folding machine (260a) and transfer the informational item (550a) from the third pressing unit (330a) to the predefined destination.

The accumulated layer thickness (t) of a head portion (548a) of the fourth folded strip (540a) which is in contact with a normal plane (546Pa) made using the method (100a) is 10 t. Similarly, the accumulated layer thickness (t) of a tail portion (548a″) of the fourth folded strip (540a) which is in contact with the normal plane (546Pa) made is 2 t. Therefore, the value of a ratio of the accumulated layer thickness (t) of the head portion (548a) to the accumulated layer thickness (t) of the tail portion (548a″) is approximately equal to the 5.

Therefore, the thickness ratio (tₛ) (refer background) of the method (100a) is lesser than the thickness ratio of the existing methods (refer background section) of making outserts. Hence, the method (100a) is increasing the easiness of the folding operation using folding machines compared to existing methods of making informational items.

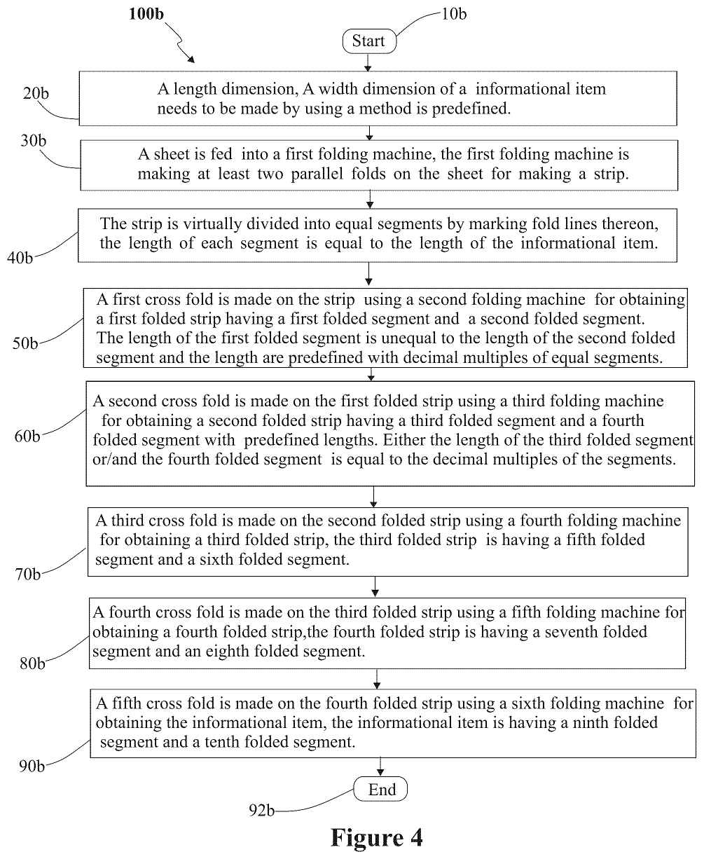

Referring now to FIG. 4, showing a flow chart of operations being carried out in an alternative embodiment of a method for making an informational item in accordance with the present invention. Hereinafter the method is referred to as the method (100b). The informational item is referred to as the informational item (550b). For the brevity of the invention, the method (100b) is explained along with machinery (200b) used for carrying out the operations of the method (100b). The informational item (550b) is having product information printed thereon. The informational item (550b) is an outsert or an insert.

The method starts at step 10b.

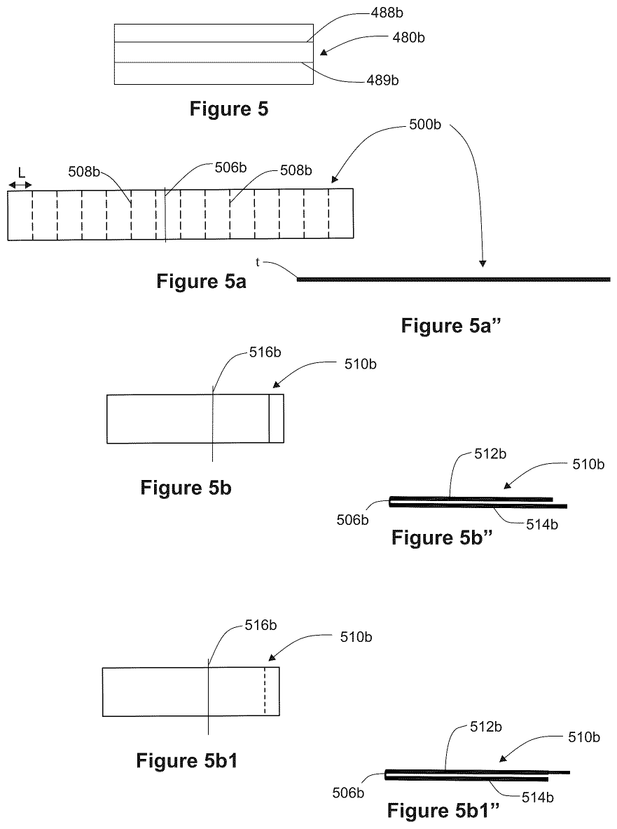

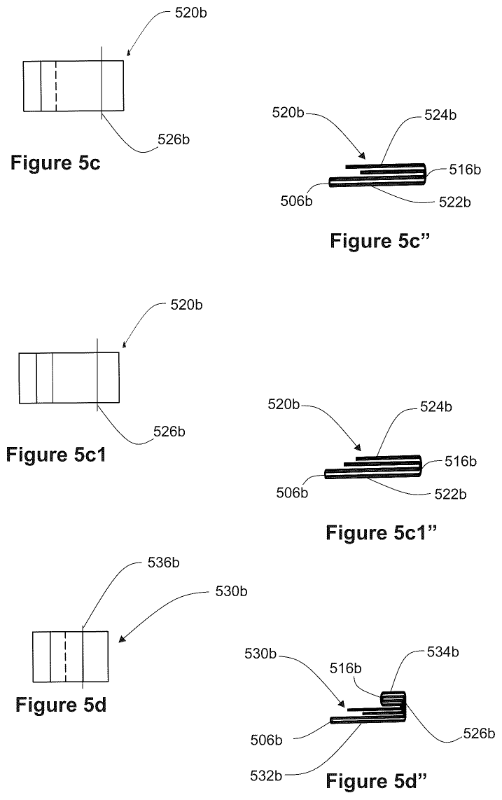

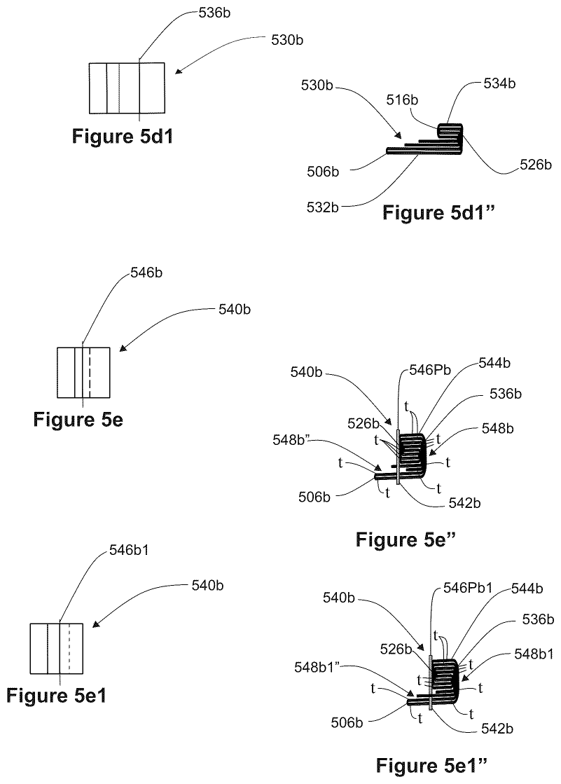

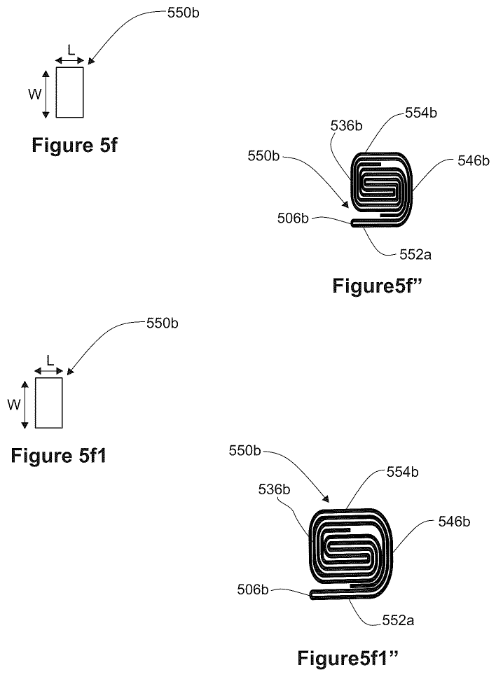

At step 20b, a length dimension, a width dimension of an expected final informational item (550b) (refer FIGS. 5f & 5f′) needs to be made by using the method (100b) is predefined. Say the length of the final informational item (550b) is “L” and the width of the final informational item is “W”.

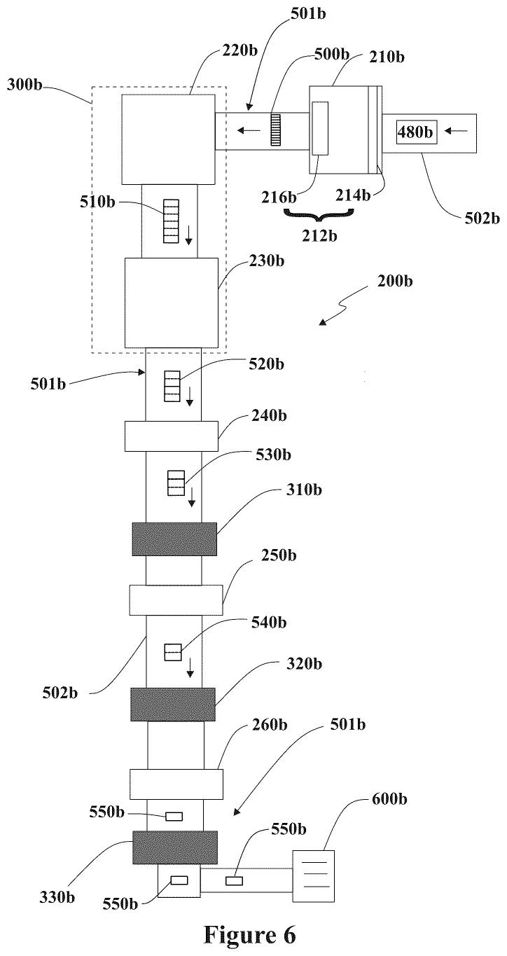

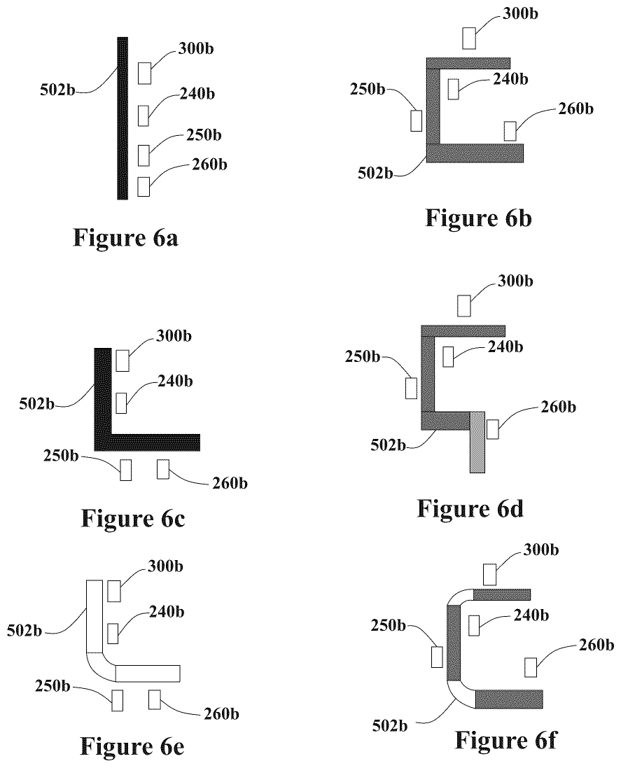

At step 30b, a sheet 480b (refer FIG. 5) is fed into a first folding machine (210b) (refer FIG. 6). The sheet (480b) is made from paper or plastic. The first folding machine (210b) is a roller folding machine. In an alternative embodiment, the first folding machine (210b) is a knife folding machine. The first folding machine (210b) adapted to receive a sheet (480b) thereto. The first folding machine (210b) is making at least two parallel folds on the sheet (480b) for making a strip (500b) (refer FIGS. 5a & 5a″). In the present embodiment, the parallel folds are made along a length direction of the sheet (480b). In an alternative embodiment, the parallel folds are made along a width direction of the sheet (480b). More specially, the parallel folds are made along fold lines (488b, 489b). The parallel folds convert the sheet (480b) into the strip (500b) with a zigzag pattern folded layers.

At step 40b, the strip (500b) is virtually divided into equal segments by marking fold lines thereon. “Virtually dividing” here refers to the strip (500b) is divided into the equal segments (l) without actually folding on the fold lines (508b). The purpose of the virtually dividing the strip (500b) is to obtain intermediate items (510b, 520b, 530b, 540b) and the informational item (550b) by making a plurality of cross folds accordingly, the intermediate items (510b, 520b, 530b, 540b) and the informational item (550b) are having lengths in terms of segments, which is defined in terms of the geometric dimensions (length and width) of the informational item (550b) obtained by the method 100b. In the present embodiment, the total length of the strip (500b) is virtually divided into fourteen equal segments (L). In an alternative embodiment, the total length of the strip (500b) is virtually divided into any obvious mathematical segments (L) which are defined based on various factors such as the total surface area of the sheet (480b), length of the strip (500b) and other requirements. The length of each segment (L) is equal to the length (L) of the informational item (550b). The first folding machine (210b) is adapted to virtually divide the strip (500b) into equal segments by marking fold lines thereon.

Further, the first folding machine (210b) includes a fold line marking unit (212b) for marking at least one virtual mark or a groove along a fold line (506b) on the strip (500b). The fold line marking unit (212b) includes mechanical elements such as rollers (216b), sprinklers (214b) or markers and the like arranged accordingly to mark the at least one virtual mark or groove for dividing the strip (500b) into a first folded segment (512b) and a second folded segment (514b). In the machinery (100b), the fold line marking unit (212b) is adapted to mark at least one virtual mark or groove on the strip (500b) with the length of the first folded segment (512b) more than or less than the length of the second folded segment (514b).

In the machinery (200b), the fold line marking unit (212b) is adapted to mark at least one virtual mark or groove on the strip (500b). The sprinklers (214b) are arranged accordingly to sprinkle the water along the at least one virtual mark on the sheet (480b) before feeding to the rollers of the first folding machine (210b), and the rollers (216b) are arranged accordingly to make the groove along at least one mark on the strip (500b).

At step 50b, a first cross fold is made on the strip (500b) using a second folding machine (220b) (refer FIG. 6) for obtaining a first folded strip (510b) (refer FIGS. 5b & 5b″). The second folding machine (220b) is adapted to receive the strip (500b) thereto. The second folding machine (220b) is a roller folding machine. In an alternative embodiment, the second folding machine (220b) is a knife folding machine.

More specifically, the second folding machine (220b) is operated to cross fold the strip (500b) along the fold line (506b) for making the first folded strip (510b). The first folded strip (510b) is having the first folded segment (512b) and the second folded segment (514b).

The length the first folded segment (512b) is unequal to the length of the second folded segment (514b). The first folded segment (512b) and the second folded segment (514b) are having predefined lengths. The predefined length of the first folded segment (512b) or/and the second folded segment (514b) is equal to decimal multiples of the segment. In this example, the length of the first folded segment (512b) is equal to the six and seven-tenths equal segments (L) and the length of the second folded segment (514b) is equal to the seven and three tenths equal segments (L).

In an alternative example as shown in FIGS. 5b1 and 5b1″, the length of the first folded segment (512b) is equal to the seven and three tenths equal segments (L) and the length of the second folded segment (514b) is equal to the six and seven-tenths equal segments (L). Proportions may vary a little bit, depending on the thickness “t” of the sample and no of segments like 14. It may be obvious to a person skilled in the art to vary a ratio of the lengths of the first folded segment (512b) and the second folded segment (514b) with various mathematical permutations and combinations in terms of lengths which are equal to multiples of decimal or whole multiples of the segments (L).

At step 60b, a second cross fold is made on the first folded strip (510b) using a third folding machine (230b) (refer FIG. 6) for obtaining a second folded strip (520b) (refer FIG. 5c, 5c″, 5c1, 5c1″). The third folding machine (230b) is adapted to receive the first folded strip (510b). The third folding machine (230b) is a roller folding machine. In an alternative embodiment, the third folding machine (230b) is a knife folding machine. In an embodiment, the second folding machine (220b) and the third folding machine (230b) are integrally mounted in a housing (300b).

More specifically, the third folding machine (230b) is operated to cross fold the first folded strip (510b) along a fold line (516b) for making the second folded strip (520b). The second folded strip (520b) is having a third folded segment (522b) and a fourth folded segment (524b). The third folded segment (522b) or the fourth folded segment (524b) are having the predefined lengths. Either length of the third folded segment (522b) or/and the fourth folded segment (524b) is equal to the decimal multiples of the segments (L).

In the shown example (FIG. 5c, 5c1, 5c″, 5c1″), the length of the third folded segment (522b) is equal to four segments, and the length of the fourth folded segment (524b) is equal to the three and three-tenths segments. It may be obvious to the person skilled in the art to vary the ratio of the lengths of the third folded segment (522b) and the fourth folded segment (524b) with various mathematical permutations and combinations in terms of lengths which are equal to multiples of decimal or whole multiples of the segments (L).

At step 70b, a third cross fold is made on the second folded strip (520b) using a fourth folding machine (240b) (refer FIG. 6) for obtaining a third folded strip (530b) (refer FIGS. 5d, 5d″, 5d1 and 5d1″). The fourth folding machine (240b) is adapted to receive the second folded strip (520b) thereto. The fourth folding machine (240b) is a roller folding machine. In an alternative embodiment, the fourth folding machine (240b) is a knife folding machine.

More specifically, the fourth folding machine (240b) is operated to cross fold the second folded strip (520b) along a fold line (526b) for making the third folded strip (530b). The third folded strip (530b) is having a fifth folded segment (532b) and a sixth folded segment (534b). The third folded strip (530b) is pressed by a first pressing unit (310b) before feeding to the fifth folding machine (250b). In this example, the length of the fifth folded segment (532b) is equal to the three equal segments (L), and the length of the sixth folded segment (534b) is equal to the one equal segment (L).

At step 80b, a fourth cross fold is made on the third folded strip (530b) using a fifth folding machine (250b) (refer FIG. 6) for obtaining a fourth folded strip (540b) (refer FIGS. 5e, 5e″, 5e1 and 5e1″). The fifth folding machine (250b) is adapted to receive the third folded strip (530b) thereto. The fifth folding machine (250b) is a roller folding machine. In an alternative embodiment, the fifth folding machine (250b) is a knife folding machine.

More specifically, the fifth folding machine (250b) is operated to cross fold the third folded strip (530b) along a fold line (536b) for making the fourth folded strip (540b). The fourth folded strip (540b) is having a seventh folded segment (542b) and an eighth folded segment (544b). The fourth folded strip (540b) is pressed by a second pressing unit (320b) before feeding to the sixth folding machine (260b). In this example, the length of the seventh folded segment (542b) is equal to the two equal segments (L) the length of the eighth folded segment (544b) is equal to the one equal segment (L).

At step 90b, a fifth cross fold is made on the fourth folded strip (540b) using a sixth folding machine (260b) (refer FIG. 6) for obtaining the informational item (550b) (refer FIG. 5e, 5e1, 5e″ & 5e1″). The sixth folding machine (260b) is adapted to receive the fourth folded strip (540b). The sixth folding machine (260b) is a roller folding machine. In an alternative embodiment, the sixth folding machine (260b) is a knife folding machine.

More specifically, the sixth folding machine (260b) is operated to cross fold the fourth folded strip (540b) along a fold line (546b) for making the fifth folded strip (550b). The informational item (550b) is having a ninth folded segment (552b) and a tenth folded segment (554b). The informational item (550b) is pressed by a third pressing unit (330b) before moving the informational item (550b) to a predefined destination. In this example, the length of the ninth folded segment (552b) is equal to the one equal segment (L), and the length of the tenth folded segment (554b) is equal to the one equal segment (L).

Fold lines of the first cross fold (506b), the second cross fold (516b), the third cross fold (526b), the fourth cross fold (536b) and the fifth cross fold (546b) are perpendicular to the length of the strip (500b).

The method (100b) ends at step (92b).

Further, the ninth folded segment (552b) and the tenth folded segment (554b) bind by a binding agent (not shown) applied accordingly thereon. The binding agent is an adhesive. The machinery (200b) includes an adhesive application unit (not shown). The adhesive application unit is operated to apply the binding agent on the ninth folded segment (552b), and the tenth folded segment (554b).

The binding agent applied ninth folded segment (552b) and the tenth folded segment (554b) are pressed accordingly for binding there together. In an alternative embodiment, the ninth folded segment (552b) and the tenth folded segment (554b) are binds by a binding member. The binding member is a clip or adhesive tape (not shown in the figure).

The machinery (100b) includes a conveyor system (501b). The conveyor system (501b) includes a conveyor path (502b) having at least one segment, the segments of the conveyor path (502b) is arranged according to the available space for arranging (set up) the machinery to configure the conveyor path. The shape of the conveyor path (502b) is “L”, “U”, “C”& “Z” (refer FIGS. 6a, 6b, 6c, 6d, 6e & 6f). The conveyor system (501b) is a belt conveyor system or a chain conveyor system or an air conveyor system.

The conveyor system (501b) is operated to transfer the sheet (480b) to the first folding machine (210b), and transfer the strip (500b) to the second folding machine (220b), transfer the first folded strip (510b) to the third folding machine (230b), transfer the second folded strip (520b) to the fourth folding machine (240b), transfer the third folded strip (530b) to the fifth folding machine (250b), transfer the fourth folded strip (540b) to the sixth folding machine (260a) and transfer the informational item (550b) to the predefined destination. The predefined destination can be a stacking unit (not shown). In an alternative embodiment of the conveyor system (501b), the conveyor system (501b) is operated to transfer the third folded strip (530b) from the first pressing unit (310b) to the fifth folding machine (250b), transfer the fourth folded strip (540b) from the second pressing unit (320b) to the sixth folding machine (260b) and transfer the informational item (550b) from the third pressing unit (330b) to the predefined destination.

The accumulated layer thickness (t) of a head portion (548b and 548b1) of the fourth folded strip (540b) which is in contact with a normal plane (546Pb and 546Pb1) made using the method (100b) is 11(t). Similarly, the accumulated layer thickness (t) of a tail portion (548b″& 548b1″) of the fourth folded strip (540b) which is in contact with a normal plane (546Pb and 546Pb1) is 3(t). Therefore, the value of the ratio of the accumulated layer thickness (t) of the tail portion (548b″) to the accumulated layer thickness (t) of the head portion (548b) is approximately equal to the 3.6. Therefore, the thickness ratio (ts) of the method (100b) is lesser than the thickness ratio the existing methods (refer background) of making outserts. Hence, the method (100b) is increasing the easiness of the folding operation using folding machines compared to existing methods of making outserts.

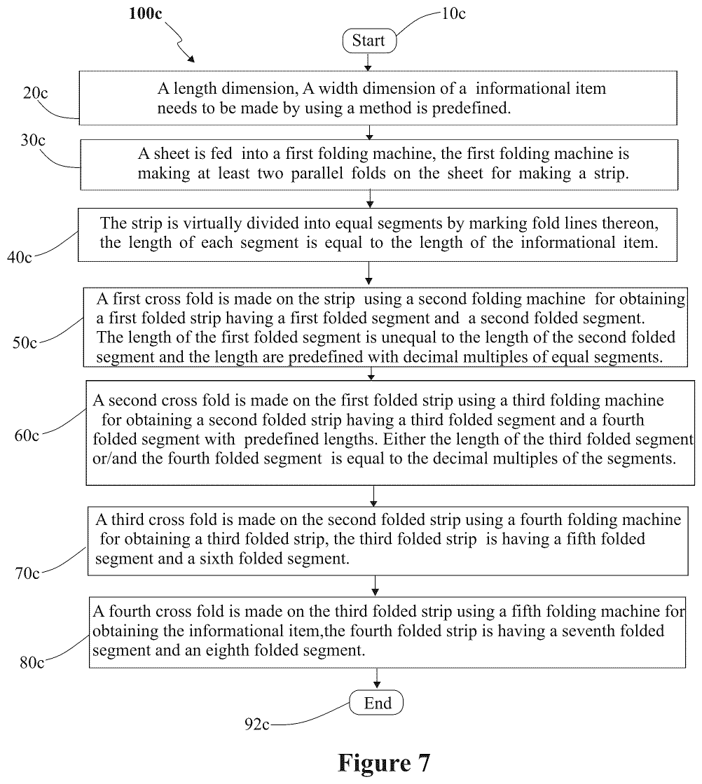

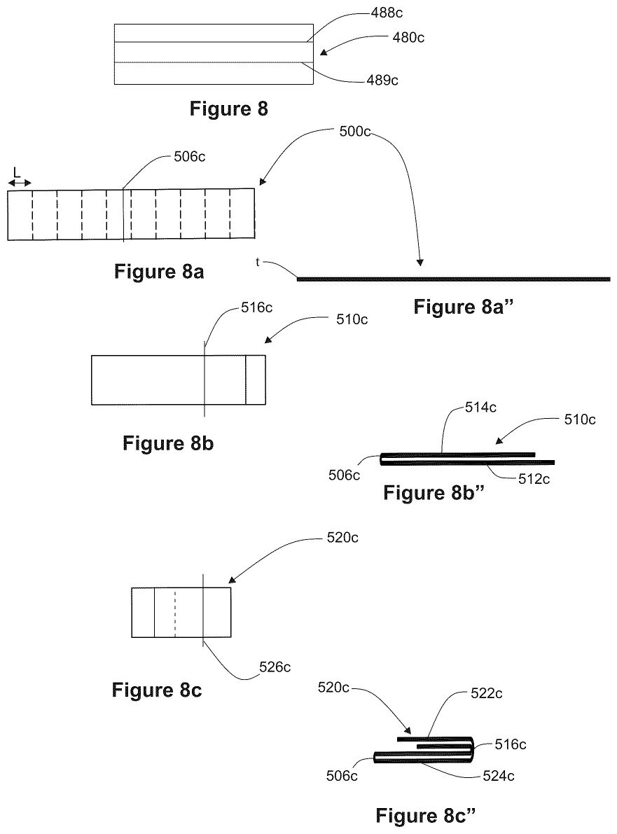

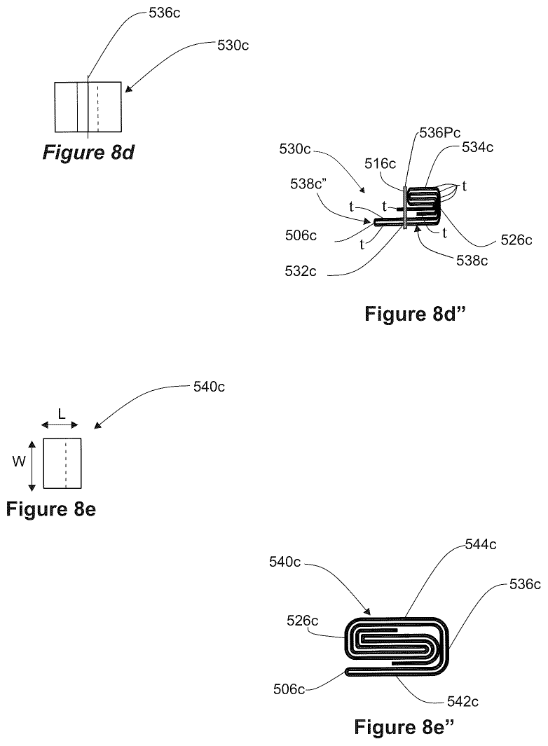

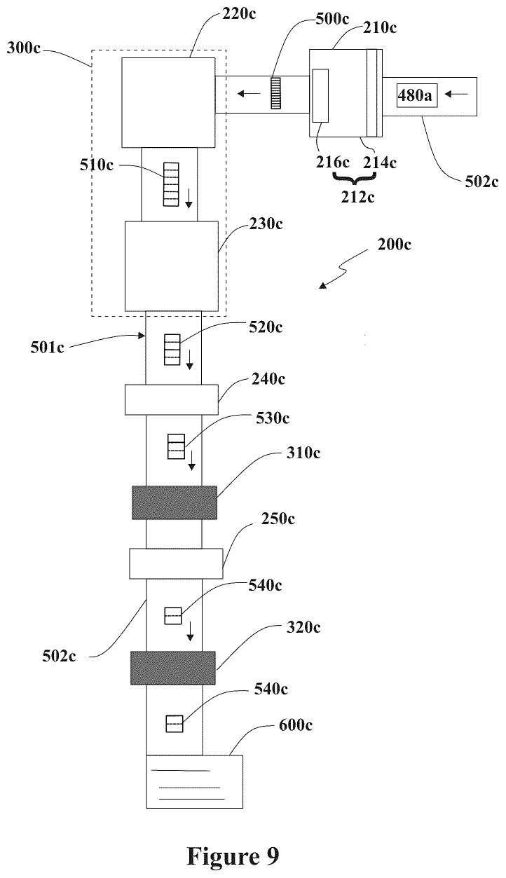

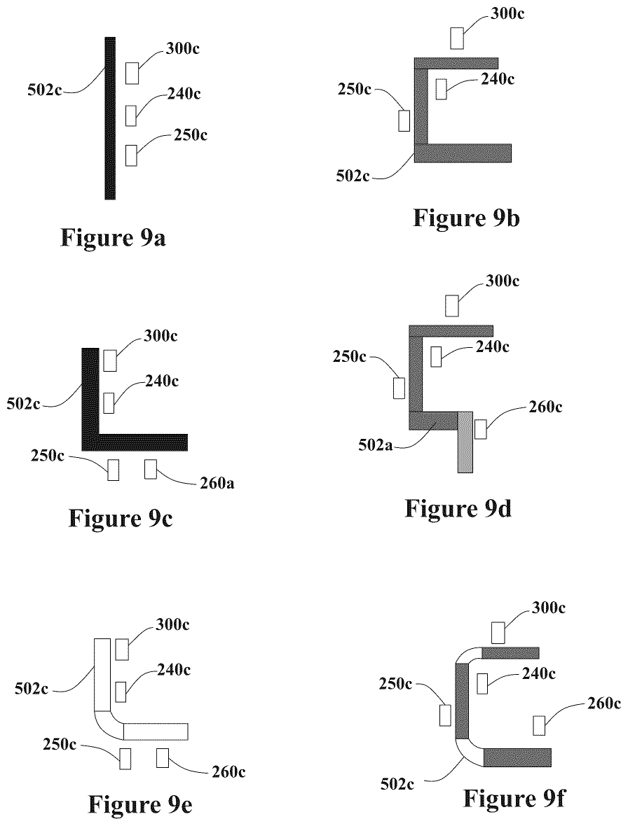

Referring now to FIG. 7 showing a flow chart of operations being carried out in an alternative method for making an informational item in accordance with the present invention. Hereinafter the method is referred to as the method (100c), the informational item is referred to as the informational item (540c) (refer FIGS. 8e and 8e″). The present invention also provides a machinery (200c) (refer FIG. 9) for making the informational item (540c). For the brevity of the invention, the method (100c) is explained along with the machinery (200c) used for carrying out the operations of the method (100c). The informational item (540c) is having the product information printed thereon. The informational item (540c) is an outsert or an insert.

The method (100c) starts at step (10c).

At step (20c), a length dimension, a width dimension of the expected final informational item (540c) needs to be made by using the method (100c) is predefined. Say the length of the final informational item (540c) is “L” and the width of the final informational item is “W”.

At step 30c, a sheet of paper 480c (refer FIG. 8) is fed into a first folding machine (210c) (refer FIG. 9). The sheet (480c) is made from paper or plastic. The first folding machine (210c) is a roller folding machine. In an alternative embodiment, the first folding machine (210c) is a knife folding machine. The first folding machine (210c) is adapted to receive the sheet (480c) thereto. The first folding machine (210c) is making at least two parallel folds on the sheet (480c) for making a strip (500c). In the present embodiment, the parallel folds are made along a length direction of the sheet (480c). In an alternative embodiment, the parallel folds are made along a width direction of the sheet (480c).

More specially, the parallel folds are made along fold lines (488c, 489c). The parallel folds convert the sheet (480c) into the strip (500c) with a zigzag pattern folded layers. It may be obvious to the person skilled in the art to make the strip (500c) by feeding the sheet (480c) into the first folding machine (210c) and operating the first folding machine (210c) for making the strip (500c) accordingly.

At step 40c, the strip (500c) is virtually divided into equal segments by marking fold lines (508c) thereon. The length of each segment is equal to a length (L) of the informational item (540c). “Virtually dividing” here refers to the strip (500c) is divided into the equal segments (L) without actually folding on the fold lines (508c). The purpose of the virtually dividing the strip (500c) is to obtain an intermediate item (510c, 520c, 530c) and the informational item (540c) by making a plurality of cross folds accordingly, the intermediate items (510c, 520c, 530c) and the informational item (540c) are having lengths in terms of segments, which is defined in terms of the geometric dimensions (length and width) of the informational item (540c) obtained by the method 100c. In the present embodiment, a total length of the strip (500c) is divided into ten equal segments (L) (refer FIG. 8a& 8a″). In an alternative embodiment, the total length of the strip (500c) is divided into any obvious mathematical segments (L) which is defined based on various factors such as the total surface area of the sheet (480c), length of the strip (500c) and other requirements. A length of each segment (L) is equal to a length (L) of the informational item (540c).

More specifically, the first folding machine (210c) includes a fold line marking unit (212c) for marking at least one virtual mark or a groove along a fold line (506c) on the strip (500c). The fold line marking unit (212c) includes mechanical elements such as rollers (216c), sprinklers (214c) or markers and the like arranged accordingly to mark the at least one virtual mark or groove for dividing the strip (500c) into a first folded segment (512c) and a second folded segment (514c). Further, the first folding machine (210c) is adapted to virtually dividing the strip (500c) into equal segments by marking fold lines (508c) thereon.

In the machinery (100c), the fold line marking unit (212c) is adapted to mark at least the one virtual mark or the groove on the strip (500c) with the length of the first folded segment (512c) is more than or less than the length of the second folded segment (514c). In the machinery (200c), the fold line marking unit (212c) is adapted to mark at least one virtual mark or groove on the strip (500c). Sprinklers (214c) are arranged accordingly to sprinkle water along the at least one virtual mark on the sheet (480c) before feeding to the rollers of the first folding machine (210c) and rollers (216c) are arranged accordingly to make the groove along at least one mark on the strip (500c).

At step 50c, a first cross fold is made on the strip (500c) using a second folding machine (220c) (refer FIG. 9) for obtaining a first folded strip (510c). The second folding machine (220c) is adapted to receive the strip (500c) thereto. The second folding machine (220c) is a roller folding machine. In an alternative embodiment, the second folding machine (220c) is a knife folding machine.

More specifically, the second folding machine (220c) is operated to cross fold the strip (500c) along the fold line (506c) for making the first folded strip (510c) (refer FIGS. 8b & 8b″). The first folded strip (510c) is having the first folded segment (512c) and the second folded segment (514c). The length of the first folded segment (512c) is unequal to the length of the second folded segment (514c). The first folded segment (512c) and the second folded segment (514c) are having predefined lengths. The predefined length of the first folded segment (512c) or/and the second folded segment (514c) is equal to decimal multiples of the segment (L).

In this example, the length of the first folded segment (512c) is equal to the five and three tenths equal segments (L) and the length of the second folded segment (514c) is equal to the four and seven-tenths equal segments (L). It may be obvious to the person skilled in the art to vary the ratio of the lengths of the first folded segment (512c) and the second folded segment (514c) with various mathematical permutations and combinations in terms of lengths which are equal to multiples of decimal or whole multiples of the segments (L).

At step 60c, a second cross fold is made on the first folded strip (510c) using a third folding machine (230c) (refer FIG. 9) for obtaining a second folded strip (520c) (refer FIGS. 8c and 8c″). In an embodiment, the second folding machine (220c) and the third folding machine (230c) are integrally mounted in a housing (300c).

The third folding machine (230c) is adapted to receive the first folded strip (510c). The third folding machine (230c) is a roller folding machine. In an alternative embodiment, the third folding machine (230c) is a knife folding machine. The third folding machine (230c) is integrally mounted in a housing (300c).

More specifically, the third folding machine (230c) is operated to cross fold the first folded strip (510c) along a fold line (516c) for making the second folded strip (520c). The second folded strip (520c) is having a third folded segment (522c) and a fourth folded segment (524c). The third folded segment (522c) and the fourth folded segment (524c) are having predefined lengths. Either the length of the third folded segment (522c) or/and the fourth folded segment (524c) is equal to the decimal multiples of the segment.

In this example, the length of the third folded segment (522c) is equal to two, and three tenths equal segments (L) and the length of the fourth folded segment (524c) is equal to the three equal segments (L). It may be obvious to persons skilled in the art to vary the ratio of the lengths of the third folded segment (522c) and the fourth folded segment (524c) with various mathematical permutations and combinations in terms of lengths which are equal to multiples of decimal or whole multiples of the segments (L).

At step 70c, a third cross fold is made on the second folded strip (520c) using a fourth folding machine (240c) (refer FIG. 9) for obtaining a third folded strip (530c) (refer FIGS. 8d and 8d″). The fourth folding machine (240c) is adapted to receive the second folded strip (520c) thereto. The fourth folding machine (240c) is a roller folding machine. In an alternative embodiment, the fourth folding machine (240c) is a knife folding machine.

More specifically, the fourth folding machine (240c) is operated to cross fold the second folded strip (520c) along a fold line (526c) for making the third folded strip (530c). The third folded strip (530c) is having a fifth folded segment (532c) and a sixth folded segment (534c). In this example, the length of the fifth folded segment (532c) is equal to the two equal segments (L), and the length of the sixth folded segment (534c) is equal to the one equal segment (L).

At step (80c), a fourth cross fold is made on the third folded strip (530c) using a fifth folding machine (250c) (refer FIG. 9) for obtaining the informational item (540c) (FIGS. 8e & 8e″). The fifth folding machine (250c) is adapted to receive the third folded strip (530c). The third folded strip (530c) is pressed by a first pressing unit (310c) before feeding to the fifth folding machine (250c). The fifth folding machine (250c) is a roller folding machine. In an alternative embodiment, the fifth folding machine (250c) is a knife folding machine.

More specifically, the fifth folding machine (250c) is operated to cross fold the third folded strip (530c) along a fold line (536c) for making the informational item (540c). The informational item (540c) is having a seventh folded segment (542b) and an eighth folded segment (544b). In this example, the length of the seventh folded segment (542c) is equal to the one equal segment (L), and the length of the eighth folded segment (544c) is equal to the one equal segment (L). The informational item (540c) is pressed by a second pressing unit (320c) before moving the informational item (540c) to a predefined destination. The predefined destination can be a stacking unit.

Fold lines of the first cross fold (506c), the second cross fold (516c), the third cross fold (526c), and the fourth cross fold (536c) are perpendicular to the length of the strip (500c).

The method (100c) ends at step (92c).

The seventh folded segment (542c) and the eighth folded segment (544c) bind by a binding agent (not shown) applied accordingly thereon. The binding agent is an adhesive. The machinery (200c) includes an adhesive application unit. The adhesive application unit is operated to apply the binding agent on the seventh folded segment (542c) and the eighth folded segment (544c). The binding agent applied seventh folded segment (542c), and the eighth folded segment (544c) are pressed accordingly for binding there together. In an alternative embodiment, the seventh folded segment (542c) and the eighth folded segment (544c) are binds by a binding member. The binding member is a clip or adhesive tape (not shown in the figure).

The machinery (100c) includes a conveyor system (501c). The conveyor system (501c) includes a conveyor path (502c) having at least one segment, the segments of the conveyor path (502c) is arranged according to the available space for arranging (set up) the machinery to configure the conveyor path. The shape of the conveyor path (502c) is “L”, “U”, “C” and “Z”(refer FIGS. 9a,9b, 9c, 9d, 9e & 9f).The conveyor system (501c) is a belt conveyor system or a chain conveyor system or an air conveyor system.

The conveyor system (501c) is operated to transfer the sheet (480c) to the first folding machine (210c), and transfer the strip (500c) to the second folding machine (220c), transfer the first folded strip (510c) to the third folding machine (230c), transfer the second folded strip (520c) to the fourth folding machine (240c), transfer the third folded strip (530c) to the fifth folding machine (250c), transfer the informational item (540c) to a predefined destination. The predefined destination can be a stacking unit (not shown). In an embodiment of the conveyor system (501c), conveyor system (501c) is operated to transfer the third folded strip (530c) from the first pressing unit (310c) to the fifth folding machine (250c) and transfer the informational item (540c) from the second pressing unit (320c) to a predefined destination.

The accumulated layer thickness (t) of a head portion (538c) of the third folded strip (530c), which is in contact with a normal plane (536Pc) made using the method (100c) is 7(t). Similarly, the accumulated layer thickness (t) of a tail portion (538c″), which is in contact with a normal plane (536Pc) of the fourth folded strip (530c) is 3(t). Therefore, the value of the ratio of the accumulated layer thickness (t) of a head portion (538c) to the accumulated layer thickness (t) of the tail portion (538c″) is approximately equal to the 2.3. Therefore, the thickness ratio (ts) (refer background) of the method (100c) is lesser than the thickness ratio the existing methods (refer background) of making outserts. Hence, the method (100c) is increasing the easiness of the folding operations using folding machines compared to existing methods.

Therefore, the present invention has an advantage of providing the methods (100a, 100b, 100c) and the machinery (200a, 200b, 200c) for making the informational items (550a, 550b, 540c). The methods (100a, 100b, 100c) and machinery (200a, 200b, 200c) increases easiness of the folding operation in making the informational items compared to existing methods of making the informational items (550a, 550b, 540c). The methods (100a, 100b, 100c) are simple in execution.

The foregoing descriptions of specific embodiments of the present invention have been presented for purposes of illustration and description. They are not intended to be exhaustive or to limit the present invention to the precise forms disclosed, and obviously, many modifications and variations are possible in light of the above teaching. The embodiments were chosen and described in order to explain best the principles of the present invention and its practical application, and to thereby enable others skilled in the art to best utilise the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

We claim:

1. A method (100a or 100b) for making an informational item (550a or 550b), the informational item (550a or 550b) is having product information printed thereon, the method (100a or 100b) comprising steps of:
feeding a sheet (480a or 480b) into a first folding machine (210a or 210b), the first folding machine (210a or 210b) is making at least two parallel folds on the sheet (480a or 480b) for making a strip (500a or 500b), wherein the strip (500a or 500b) is virtually divided into equal segments by marking a fold line (508a or 508b) thereon;
making a first cross fold on the strip (500a or 500b) using a second folding machine (220a or 220b) for obtaining a first folded strip (510a or 510b), the first folded strip (510a or 510b) is having a first folded segment (512a or 512b) and a second folded segment (514a or 514b), wherein the length the first folded segment (512a or 512b) is equal or unequal to the length of the second folded segment (514a or 514b); and the first folded segment (512a or 512b) and the second folded segment (514a or 514b) are having predefined lengths;
making a second cross fold on the first folded strip (510a or 510b) using a third folding machine (230a or 230b) for obtaining a second folded strip (520a or 520b), the second folded strip (520a or 520b) is having a third folded segment (522a or 522b), and a fourth folded segment (524a or 524b); the third folded segment (522a or 522b) and/or the fourth folded segment (524a or 524b) are having predefined lengths;
making a third cross fold on the second folded strip (520a or 520b) using a fourth folding machine (240a or 240b) for obtaining a third folded strip (530a or 530b), the third folded strip (530a or 530b) is having a fifth folded segment (532a or 532b), and a sixth folded segment (534a or 534b);
making a fourth cross fold on the third folded strip (530a or 530b) using a fifth folding machine (250a or 250b) for obtaining a fourth folded strip (540a or 540b), the fourth folded strip (540a or 540b) is having a seventh folded segment (542a or 542b), and an eighth folded segment (544a or 544b);
making a fifth cross fold on the fourth folded strip (540a or 540b) using a sixth folding machine (260a or 260b) for obtaining the informational item (550a or 550b), the informational item (550a or 550b) is having a ninth folded segment (552a or 552b) and a tenth folded segment (554a or 554b).

2. A method (100b) for making an informational item (550b), the informational item (550b) is having product information printed thereon, the method (100b) comprising steps of:
feeding a sheet (480b) into a (210b), the first folding machine (210b) is making at least two parallel folds on the sheet (480b) for making a strip (500b), wherein the strip (500b) is virtually divided into equal segments by marking fold lines (508b) thereon; the length of each segment is equal to a length (L) of the informational item (550b);
making a first cross fold on the strip (500b) using a second folding machine (220b) for obtaining a first folded strip (510b), the first folded strip (510b) is having a first folded segment (512b) and a second folded segment (514b), wherein the length the first folded segment (512b) is unequal to the length of the second folded segment (514b); and the first folded segment (512b) and the second folded segment (514b) are having predefined lengths, the predefined length of the first folded segment (512b) or/and the second folded segment (514b) is equal to decimal multiples of the equal segment;
making a second cross fold on the first folded strip (510b) using a third folding machine (230b) for obtaining a second folded strip (520b), the second folded strip (520b) is having a third folded segment (522b), and a fourth folded segment (524b); the third folded segment (522b) or the fourth folded segment (524b) are having predefined lengths; either the length of the third folded segment (522b) or/and the fourth folded segment (524b) is equal to the decimal multiples of the equal segments;
making a third cross fold on the second folded strip (520b) using a fourth folding machine (240b) for obtaining a third folded strip (530b), the third folded strip (530b) is having a fifth folded segment (532b) and a sixth folded segment (534b);
making a fourth cross fold on the third folded strip (530b) using a fifth folding machine (250b) for obtaining a fourth folded strip (540b), the fourth folded strip (540b) is having a seventh folded segment (542b) and an eighth folded segment (544b); and
making a fifth cross fold on the fourth folded strip (540b) using a sixth folding machine (260b) for obtaining the informational item (550b), the informational item (550b) is having a ninth folded segment (552b) and a tenth folded segment (554b).

3. A method (100b) for making an informational item (550b), the informational item (550b) is having product information printed thereon, the method (100b) comprising steps of:
feeding a sheet (480b) into a (210b), the first folding machine (210b) is making at least two parallel folds on the sheet (480b) for making a strip (500b), wherein the strip (500b) is virtually divided into fourteen equal segments by marking fold lines (508b) thereon; the length of each segment is equal to the length (L) of the informational item (550b);
making a first cross fold on the strip (500b) using a second folding machine (220b) for obtaining a first folded strip (510b), the first folded strip (510b) is having a first folded segment (512b) and a second folded segment (514b), wherein the length the first folded segment (512b) is unequal to the length of the second folded segment (514b); the length of the first folded segment (512b) is equal to the seven and three-tenths segments or six and seven-tenths equal segments (L) and the length of the second folded segment (514b) is equal to the six and seven-tenths equal segments or the seven and three-tenths segments;
making a second cross fold on the first folded strip (510b) using a third folding machine (230b) for obtaining a second folded strip (520b), the second folded strip (520b) is having a third folded segment (522b), and a fourth folded segment (524b); the length of the third folded segment (522b) is equal to four segments and the length of the fourth folded segment (524b) is equal to three and three-tenths segments;
making a third cross fold on the second folded strip (520b) using a fourth folding machine (240b) for obtaining a third folded strip (530b), the third folded strip (530b) is having a fifth folded segment (532b), and a sixth folded segment (534b);
making a fourth cross fold on the third folded strip (530b) using a fifth folding machine (250b) for obtaining a fourth folded strip (540b), the fourth folded strip (540b) is having a seventh folded segment (542b), and an eighth folded segment (544b); and
making a fifth cross fold on the fourth folded strip (540b) using a sixth folding machine (260b) for obtaining the informational item (550b), the informational item (550b) is having a ninth folded segment (552b) and a tenth folded segment (554b).

4. A method (100a) for making an informational item (550a), the informational item (550a) is having product information printed thereon, the method (100a) comprising steps of:
feeding a sheet (480a) into a (210a), the first folding machine (210a) is making at least two parallel folds on the sheet (480a) for making a strip (500a), wherein the strip (500a) is virtually divided into twelve equal segments by marking fold lines (508a) thereon; the length of each segment (L) is equal to a length of the informational item (550a);
making a first cross fold on the strip (500a) using a second folding machine (220a) for obtaining a first folded strip (510a), the first folded strip (510a) is having a first folded segment (512a) and a second folded segment (514a), wherein the length the first folded segment (512a) is equal to the length of the second folded segment (514a); the first folded segment (512a) and the second folded segment (514a) is equal to six equal segments;
making a second cross fold on the first folded strip (510a) using a third folding machine (230a) for obtaining a second folded strip (520a), the second folded strip (520a) is having a third folded segment (522a), and a fourth folded segment (524a); and the length of the third folded segment (522a) is equal to four equal segments (L) or/and the length of the fourth folded segment (524a) is equal to two equal segments;
making a third cross fold on the second folded strip (520a) using a fourth folding machine (240a) for obtaining a third folded strip (530a), the third folded strip (530a) is having a fifth folded segment (532a), and a sixth folded segment (534a); the length of the fifth folded segment (532a) is equal to three equal segments, and the length of the sixth folded segment (534a) is equal to one equal segment;
making a fourth cross fold on the third folded strip (530a) using a fifth folding machine (250a) for obtaining a fourth folded strip (540a), the fourth folded strip (540a) is having a seventh folded segment (542a) and an eighth folded segment (544a); and the length of the seventh folded segment (542a) is equal to two equal segments, and the length of the eighth folded segment (544a) is equal to one equal segment; and
making a fifth cross fold on the fourth folded strip (540a) using a sixth folding machine (260a) for obtaining the informational item (550a), the informational item (550a) is having a ninth folded segment (552a) and a tenth folded segment (554a) and the length of the ninth folded segment (552a) and the tenth folded segment (554a) is equal to one equal segment.

5. The method (100a or 100b) as claimed in claims 1, 2, 3 & 4, wherein the sheet (480a or 480b) is made from paper or plastic.

6. The method (100a or 100b) as claimed in claims 1, 2, 3 & 4, wherein the first folding machine (210a or 210b) is a roller folding machine, the second folding machine (220a or 220b) is a roller folding machine, the third folding machine (230a or 230b) is a roller folding machine, the fourth folding machine (240a or 240b) is a roller folding machine, the fifth folding machine (250a or 250b) is a roller folding machine, and the sixth folding machine (260a or 260b) is a roller folding machine, the roller folding machine includes a plurality of rollers, the plurality of rollers are operated perform the folding operation.

7. The method (100a or 100b) as claimed in claims 1, 2, 3 & 4, wherein the first folding machine (210a 210b) is a knife folding machine, the second folding machine (220a or 220b) is a knife folding machine, the third folding machine (230a 230b) is a knife folding machine, the fourth folding machine (240a or 240b) is a knife folding machine, the fifth folding machine (250a or 250b) is a knife folding machine, and the sixth folding machine (260a or 260b) is a knife folding machine, the knife folding machine includes a knife, the knife is operated perform a folding operation.

8. The method (100a or 100b) as claimed in claims 1, 2, 3 & 4, wherein fold lines of the first cross fold, the second cross fold, the third cross fold, the fourth cross fold and the fifth cross fold are perpendicular to the length of the strip (550a, 550b).

9. The method (100a or 100b) as claimed in claims 1, 2, 3 &4, wherein the ninth folded segment (552a or 552b) and the tenth folded segment (554a or 554b) are bind by a binding agent applied thereon; the binding agent is an adhesive or the ninth folded segment (552a or 552b) and the tenth folded segment (554a or 554b) are bound by a binding member, the binding member is a clip or adhesive tape.

10. The method (100a or 100b) as claimed in claims 1, 2, 3 &4, wherein the third folded strip (530a or 530b) is pressed by a first pressing unit (310a or 310b) before feeding to the fifth folding machine (250a or 250b), the fourth folded strip (540a or 540b) is pressed by a second pressing unit (320a or 320b) before feeding to the sixth folding machine (260a or 260b), and the informational item (550a or 550b) is pressed by a third pressing unit (330a or 330b) before moving the informational item (550a or 550b) to a predefined destination.

11. A Machinery (200a or 200b) for making an informational item (550a or 550b), the informational item (550a or 550b) is having product information printed thereon, and the machinery (200a or 200b) comprises:
a first folding machine (210a or 210b) adapted to receive a sheet (480a or 480b) thereto, the first folding machine (210a or 210b) makes at least two parallel folds on the received sheet (480a or 480b) for making a strip (500a or 500b), wherein the first folding machine (210a or 210b) is adapted to virtually dividing the strip (500a or 500b) into equal segments by marking fold lines (508a or 508b) thereon;
a second folding machine (220a or 220b) adapted to receive the strip (500a or 500b) thereto, the second folding machine (220a or 220b) makes a first cross fold on the strip (500a or 500b) for making a first folded strip (510a or 510b), the first folded strip (510a or 510b) is having a first folded segment (512a or 512b) and a second folded segment (514a or 514b), wherein the length the first folded segment (512a or 512b) is equal or unequal to the length of the second folded segment (514a or 514b); the first folded segment (512a & 512b) and the second folded segment (514a& 514b) are having predefined lengths;
a third folding machine (230a or 230b) adapted to receive the first folded strip (510a or 510b), the third folding machine (230a or 230b) makes a second cross fold on the first folded strip (510a or 510b) for making a second folded strip (520a or 520b), the second folded strip (520a or 520b) is having a third folded segment (522a or 522b), and a fourth folded segment (524a or 524b), the third folded segment (522a or 522b) or the fourth folded segment (524a or 524b) are having predefined lengths;
a fourth folding machine (240a or 240b) adapted to receive the second folded strip (520a or 520b) thereto, the fourth folding machine (240a or 240b) makes a third cross fold on the second folded strip (520a or 520b) for making a third folded strip (530a or 530b), the third folded strip (530a or 530b) is having a fifth folded segment (532a or 532b), and a sixth folded segment (534a or 534b);
a fifth folding machine (250a or 250b) adapted to receive the third folded strip (530a or 530b) thereto, the fifth folding machine (250a or 250b) makes a fourth cross fold on the third folded strip (530a or 530b) for making a fourth folded strip (540a or 540b), the fourth folded strip (540a or 540b) is having a seventh folded segment (542a or 542b), and an eighth folded segment (544a or 544b);
a sixth folding machine (260a or 260b) adapted to receive the fourth folded strip (540a or 540b), the sixth folding machine (260a or 260b) makes a fifth cross fold on the fourth folded strip (540a or 540b) for making the informational item (550a or 550b), the informational item (550a or 550b) is having a ninth folded segment (552a or 552b), and a tenth folded segment (554a or 554b).

12. A Machinery (200b) for making an informational item (550b), the informational item (550b) is having product information printed thereon, and the machinery (200b) comprises:
a first folding machine (210b) adapted to receive a sheet (480b) thereto, the first folding machine (210b) makes at least two parallel folds on the received sheet (480b) for making a strip (500b), wherein the first folding machine (210b) is adapted to virtually dividing the strip (500b) into equal segments by marking fold lines (508b) thereon, and the length of each segment is equal to a length (L) of the informational item (550b);
a second folding machine (220b) adapted to receive the strip (500b) thereto, the second folding machine (220b) makes a first cross fold on the strip (500b) for making a first folded strip (510b), the first folded strip (510b) is having a first folded segment (512b) and a second folded segment (514b), wherein the length the first folded segment (512b) is unequal to the length of the second folded segment (514b); the first folded segment (512b) and the second folded segment (514b) are having predefined lengths, the predefined length of the first folded segment (512b) or/and the second folded segment (514b) is equal to decimal multiples of the segment;
a third folding machine (230b) adapted to receive the first folded strip (510b), the third folding machine (230b) makes a second cross fold on the first folded strip (510b) for making a second folded strip (520b), the second folded strip (520b) is having a third folded segment (522b), and a fourth folded segment (524b), the third folded segment (522b) or the fourth folded segment (524b) are having predefined lengths, either the length of the third folded segment (522b) or/and the fourth folded segment (524b) is equal to the decimal multiples of the segment;
a fourth folding machine (240b) adapted to receive the second folded strip (520b) thereto, the fourth folding machine (240b) makes a third cross fold on the second folded strip (520b) for making a third folded strip (530b), the third folded strip (530b) is having a fifth folded segment (532b), and a sixth folded segment (534b);
a fifth folding machine (250b) adapted to receive the third folded strip (530b) thereto, the fifth folding machine (250b) makes a fourth cross fold on the third folded strip (530b) for making a fourth folded strip (540b), the fourth folded strip (540b) is having a seventh folded segment (542b), and an eighth folded segment (544b);
a sixth folding machine (260b) adapted to receive the fourth folded strip (540b), the sixth folding machine (260b) makes a fifth cross fold on the fourth folded strip (540b) for making the informational item (550b), the informational item (550b) is having a ninth folded segment (552b), and a tenth folded segment (554b).

13. A Machinery (200b) for making an informational item (550b), the informational item (550b) is having product information printed thereon, and the machinery (200b) comprises:
a first folding machine (210b) adapted to receive a sheet (480b) thereto, the first folding machine (210b) makes at least two parallel folds on the received sheet (480b) for making a strip (500b), wherein the first folding machine (210b) is adapted to virtually dividing the strip (500b) into fourteen equal segments by marking fold lines (508b) thereon, and the length of each segment is equal to a length (L) of the informational item (550b);
a second folding machine (220b) adapted to receive the strip (500b) thereto, the second folding machine (220b) makes a first cross fold on the strip (500b) for making a first folded strip (510b), the first folded strip (510b) is having a first folded segment (512b) and a second folded segment (514b), wherein the length the first folded segment (512b) is unequal to the length of the second folded segment (514b), the length of the first folded segment (512b) is equal to the seven and three-tenths segments or six and seven-tenths equal segments (L) and the length of the second folded segment (514b) is equal to the seven-tenths equal segments or the seven and three-tenths segments;
a third folding machine (230b) adapted to receive the first folded strip (510b), the third folding machine (230b) makes a second cross fold on the first folded strip (510b) for making a second folded strip (520b), the second folded strip (520b) is having a third folded segment (522b), and a fourth folded segment (524b), the length of the third folded segment (522b) is equal to four segments, and the length of the fourth folded segment (524b) is equal to the three and three-tenths segments;
a fourth folding machine (240b) adapted to receive the second folded strip (520b) thereto, the fourth folding machine (240b) makes a third cross fold on the second folded strip (520b) for making a third folded strip (530b), the third folded strip (530b) is having a fifth folded segment (532b), and a sixth folded segment (534b);
a fifth folding machine (250b) adapted to receive the third folded strip (530b) thereto, the fifth folding machine (250b) makes a fourth cross fold on the third folded strip (530b) for making a fourth folded strip (540b), the fourth folded strip (540b) is having a seventh folded segment (542b), and an eighth folded segment (544b);
a sixth folding machine (260b) adapted to receive the fourth folded strip (540b), the sixth folding machine (260b) makes a fifth cross fold on the fourth folded strip (540b) for making the informational item (550b), the informational item (550b) is having a ninth folded segment (552b), and a tenth folded segment (554b).

14. A Machinery (200a) for making an informational item (550a), the informational item (550a) is having product information printed thereon, and the machinery (200a) comprises:
a first folding machine (210a) adapted to receive a sheet (480a) thereto, the first folding machine(210a) makes at least two parallel folds on the received sheet (480a) for making a strip (500a), wherein the first folding machine (210a) is adapted to virtually dividing the strip (500a) into equal segments by marking fold lines (508a) thereon;
a second folding machine (220a) adapted to receive the strip (500a) thereto, the second folding machine (220a) makes a first cross fold on the strip (500a) for making a first folded strip (510a), the first folded strip (510a) is having a first folded segment (512a) and a second folded segment (514a), wherein the length the first folded segment (512a) is equal the length of the second folded segment (514a) and the length of the first folded segment (512a) and the second folded segment (514a) is equal to six equal segments;
a third folding machine (230a) adapted to receive the first folded strip (510a), the third folding machine (230a) makes a second cross fold on the first folded strip (510a) for making a second folded strip (520a), the second folded strip (520a) is having a third folded segment (522a), and a fourth folded segment (524a), the length of the third folded segment (522a) is equal to four equal segments or/and the length of the fourth folded segment (524a) is equal to two equal segments;
a fourth folding machine (240a) adapted to receive the second folded strip (520a) thereto, the fourth folding machine (240a) makes a third cross fold on the second folded strip (520a) for making a third folded strip (530a), the third folded strip (530a) is having a fifth folded segment (532a), and a sixth folded segment (534a), the length of the fifth folded segment (532a) is equal to three or one equal segments, and the length of the sixth folded segment (534a) is equal to three or one equal segments;
a fifth folding machine (250a) adapted to receive the third folded strip (530a) thereto, the fifth folding machine (250a) makes a fourth cross fold on the third folded strip (530a) for making a fourth folded strip (540a), the fourth folded strip (540a) is having a seventh folded segment (542a), and an eighth folded segment (544a), the length of the seventh folded segment (542a) is equal to two or one equal segment and the length of the eighth folded segment (544a) is equal to two or one equal segment;
a sixth folding machine (260a) adapted to receive the fourth folded strip (540a), the sixth folding machine (260) makes a fifth cross fold on the fourth folded strip (540) for making the informational item (550a), the informational item (550a) is having a ninth folded segment (552a), and a tenth folded segment (554a), the length of the ninth folded segment (552a) and the tenth folded segment (554a) is equal to one equal segment.

15. The machinery (200a or 200b) as claimed in claims 11,12, 13 & 14, wherein the first folding machine (210a or 210b) is a roller folding machine, the second folding machine (220a or 220b) is a roller folding machine, the third folding machine (230a or 230b) is a roller folding machine, the fourth folding machine (240a or 240b) is a roller folding machine, the fifth folding machine (250a or 250b) is a roller folding machine, and the sixth folding machine (260a or 260b) is a roller folding machine, the roller folding machine includes a plurality of rollers, the plurality of rollers are operated perform the folding operation.

16. The machinery (200a or 200b) as claimed in claims 11,12, 13 & 14, wherein the first folding machine (210a or 210b) is a knife folding machine, the second folding machine (220a or 220b) is a knife folding machine, the third folding machine (230a 230b) is a knife folding machine, the fourth folding machine (240a or 240b) is a knife folding machine, the fifth folding machine (250a or 250b) is a knife folding machine, and the sixth folding machine (260a or 260b) is a knife folding machine, the knife folding machine includes a knife, the knife is operated perform a folding operation.

17. The machinery (200a or 200b) as claimed in claims 11,12,13 & 14, wherein the second folding machine (220a or 220b) and the third folding machine (230a or 230b) are integrally mounted in a housing (300a or 300b).

18. The machinery (200a or 200b) as claimed in claims 11,12, 13 & 14, wherein fold lines of the first cross fold, the second cross fold, the third cross fold, the fourth cross fold and the fifth cross fold are perpendicular to the length of the strip (500a, 500b).

19. The machinery (200a) as claimed in claims 11 & 14, the first folding machine (210a) includes a fold line marking unit (212a), the fold line marking unit (212a) includes mechanical elements such as rollers (216a), sprinklers (214a) or markers and the like arranged accordingly to mark the at least one virtual mark or groove for dividing the strip (500a) into the first folded segment (512a) and a second folded segment (514a), wherein the length of the first folded segment (512a) is equal the length of the second folded segment (514a), wherein sprinklers (214a) are arranged accordingly to sprinkle water along the at least one virtual mark on the sheet (480a) before feeding to the rollers of the first folding machine (210a) and rollers (216a) are arranged accordingly to make the groove along at least one mark on the strip (500a).

20. The machinery (200b) as claimed in claims 11,12 & 13, the first folding machine (210b) includes a fold line marking unit (212b), the fold line marking unit (212b) includes mechanical elements such as rollers (216b), sprinklers (214b) or markers and the like arranged accordingly to mark the at least one virtual mark or groove for dividing the strip (500b) into the first folded segment (512b) and a second folded segment (514b), wherein the length of the first folded segment (512b) is more than the length of the second folded segment (514b), wherein sprinklers (214b) are arranged accordingly to sprinkle water along the at least one virtual mark on the sheet (480b) before feeding to the rollers of the first folding machine (210b) and rollers (216b) are arranged accordingly to make the groove along at least one mark on the strip (500b).

21. The machinery (200b) as claimed in claims 11,12 & 13, the first folding machine (210b) includes a fold line marking unit (212b), the fold line marking unit (212b) includes mechanical elements such as rollers (216b), sprinklers (214b) or markers and the like arranged accordingly to mark the at least one virtual mark or groove for dividing the strip (500b) into the first folded segment (512b) and a second folded segment (514b), wherein the length of the first folded segment (512b) is less than the length of the second folded segment (514b), wherein sprinklers (214b) are arranged accordingly to sprinkle water along the at least one virtual mark on the sheet (480b) before feeding to the rollers of the first folding machine (210b) and rollers (216b) are arranged accordingly to make the groove along at least one mark on the strip (500b).

22. The machinery (200a or 200b) as claimed in claims 11,12,13 & 14, wherein the machinery (200a or 200b) includes an adhesive application unit, the adhesive application unit is operated to apply a binding agent on the ninth folded segment (552a) and the tenth folded segment (554a) and the binding agent applied ninth folded segment (552a) and the tenth folded segment (554a) are pressed accordingly for binding there together, and the binding agent is an adhesive.

23. The machinery (100a or 100b) as claimed in claims 11,12,13 & 14, wherein the machinery includes a first pressing unit (310a or 310b) for pressing the third folded strip (530a or 530b) before feeding to the fifth folding machine (250a or 250b), a second pressing unit (320a or 320b) for pressing the fourth folded strip (540a or 540b) before feeding to the sixth folding machine (260a or 260b) and a third pressing unit (330a or 330b) for pressing the informational item (550a or 550b) before moving the informational item (550a or 550b) to a predefined destination.

24. The machinery (200a or 200b) as claimed in claims 11,12,13 & 14, wherein the machinery includes a conveyor system (501a or 501b), the conveyor system (501a or 501b) is operated to transfer the sheet (480a or 480b) to the first folding machine (210a or 210b), and transfer the strip (500a 500b) to the second folding machine (220a or 220b), transfer the first folded strip (510a or 510b) to the third folding machine (230a or 230b), transfer the second folded strip (520a or 520b) to the fourth folding machine (240a or 240b), transfer the third folded strip (530a or 530b) to the fifth folding machine (250a or 250b), transfer the fourth folded strip (540a or 540b) to the sixth folding machine (260a or 260b) and transfer the informational item(550a or 550b) to a predefined destination.

25. The machinery (200a or 200b) as claimed in claims 11,12,13,14 & 23, wherein the machinery includes a conveyor system (501a or 501b), the conveyor system (501a or 501b) is operated to transfer the sheet (480a or 480b) to the first folding machine (210a or 210b), and transfer the strip (500a 500b) to the second folding machine (220a or 220b), transfer the first folded strip (510a or 510b) to the third folding machine (230a or 230b), transfer the second folded strip (520a or 520b) to the fourth folding machine (240a or 240b), transfer the third folded strip (530a or 530b) from the first pressing unit (310a or 310b) to the fifth folding machine (250a or 250b), transfer the fourth folded strip (540a or 540b) from the second pressing unit (320a or 320b) to the sixth folding machine (260a or 260b) and transfer the informational item(550a or 550b)) from the third pressing unit (330a or 330b) to a predefined destination.

26. The machinery (200a or 200b) as claimed in claims 24 & 25, wherein a conveyor system (501a or 501b) includes a conveyor path (502a or 502b) having at least one segment, the segments of the conveyor path (502a or 502b, 503a or 503b) is (are) arranged according to the available space for arranging (set up) the machinery to configure the conveyor path.

27. The machinery (200a or 200b) as claimed in claim 26, wherein the shape of the conveyor path (502a or 502b) is “L”, “U”, “C” & “Z”.

28. The machinery (200a or 200b) as claimed in claim 24&25, wherein the conveyor system (501a or 501b) is a belt conveyor system or a chain conveyor system or air conveyor system.

29. A method (100c) for making an informational item (540c), the informational item (540c) is having product information printed thereon, the method (100c) comprising steps of:
feeding a sheet (480c) into a first folding machine (210c), the first folding machine (210c) is making at least two parallel folds on the sheet (480c) for making a strip (500c), wherein the strip (500c) is virtually divided into equal segments by marking fold lines (508c) thereon;
making a first cross fold on the strip (500c) using a second folding machine (220c) for obtaining a first folded strip (510c), the first folded strip (510c) is having a first folded segment (512c) and a second folded segment (514c), wherein the length of the first folded segment (512c) is unequal to the length of the second folded segment (514c), the first folded segment (512c) and the second folded segment (514c) are having predefined lengths;
making a second cross fold on the first folded strip (510c) using a third folding machine (230c) for obtaining a second folded strip (520c), the second folded strip (520c) is having a third folded segment (522c) and a fourth folded segment (524c), the third folded segment (522c) and the fourth folded segment (524c) are having predefined lengths;
making a third cross fold on the second folded strip (520c) using a fourth folding machine (240c) for obtaining a third folded strip (530c), the third folded strip (530c) is having a fifth folded segment (532c), and a sixth folded segment (534c); and
making a fourth cross fold on the third folded strip (530c) using a fifth folding machine (250c) for obtaining the informational item(540c), the informational item (540c) is having a seventh folded segment (542c), and an eighth folded segment (544c).

30. A method (100c) for making an informational item (540c), the informational item (540c) is having product information printed thereon, the method (100c) comprising steps of:
feeding a sheet (480c) into a first folding machine (210c), the first folding machine (210c) is making at least two parallel folds on the sheet (480c) for making a strip (500c), wherein the strip (500c) is virtually divided into equal segments by marking fold lines (508a) thereon, the length of each segment is equal to a length (L) of the informational item (540c);
making a first cross fold on the strip (500c) using a second folding machine (220c) for obtaining a first folded strip (510c), the first folded strip (510c) is having a first folded segment (512c) and a second folded segment (514c), wherein the length of the first folded segment (512c) is unequal to the length of the second folded segment (514c), the first folded segment (512c) and the second folded segment (514c) are having predefined lengths, the predefined length of the first folded segment (512c) or/and the second folded segment (514c) is equal to decimal multiples of the segment;
making a second cross fold on the first folded strip (510c) using a third folding machine (230c) for obtaining a second folded strip (520c), the second folded strip (520c) is having a third folded segment (522c) and a fourth folded segment (524c), the third folded segment (522c) and the fourth folded segment (524c) are having predefined lengths, either the length of the third folded segment (522c) or/and the fourth folded segment (524c) is equal to the decimal multiples of the segment(L);
making a third cross fold on the second folded strip (520c) using a fourth folding machine(240c) for obtaining a third folded strip (530c), the third folded strip (530c) is having a fifth folded segment (532c), and a sixth folded segment (534c); and
making a fourth cross fold on the third folded strip (530c) using a fifth folding machine (250c) for obtaining the informational item(540c), the informational item (540c) is having a seventh folded segment (542c), and an eighth folded segment (544c).

31. A method (100c) for making an informational item (540c), the informational item (540c) is having product information printed thereon, the method (100c) comprising steps of:
feeding a sheet (480c) into a first folding machine (210c), the first folding machine (210c) is making at least two parallel folds on the sheet (480c) for making a strip (500c), wherein the strip (500c) is virtually divided into ten equal segments by marking fold lines thereon, the length of each segment is equal to a length (L) of the informational item (540c);
making a first cross fold on the strip (500c) using a second folding machine (220c) for obtaining a first folded strip (510c), the first folded strip (510c) is having a first folded segment (512c) and a second folded segment (514c), the length of the first folded segment (512c) is unequal to the length of the second folded segment (514c); the length of the first folded segment (512c) is equal to the five and three tenths or four and seven-tenths equal segments (L) and the length of the second folded segment (514c) is equal to four and seven-tenths or five and three tenths equal segments;
making a second cross fold on the first folded strip (510c) using a third folding machine (230c) for obtaining a second folded strip (520c), the second folded strip (520c) is having a third folded segment (522c) and a fourth folded segment (524c), the length of the third folded segment (522c) is equal to two and three tenths, and the length of the fourth folded segment (524c) is equal to three equal segments;
making a third cross fold on the second folded strip (520c) using a fourth folding machine(240c) for obtaining a third folded strip(530c), the third folded strip (530c) is having a fifth folded segment (532c), and a sixth folded segment (534c); and
making a fourth cross fold on the third folded strip (530c) using a fifth folding machine (250c) for obtaining the informational item(540c), the informational item (540c) is having a seventh folded segment (542c), and an eighth folded segment (544c).

32. The method (100c) as claimed in claims 29, 30 & 31, wherein the sheet (480c) is made from paper or plastic.

33. The method (100c) as claimed in claims 29, 30 & 31, wherein the first folding machine (210c) is a roller folding machine, the second folding machine (220c) is a roller folding machine, the third folding machine (230c) is a roller folding machine, the fourth folding machine (240c) is a roller folding machine, and the fifth folding machine (250c) is a roller folding machine, the roller folding machine includes a plurality of rollers, the plurality of rollers is operated perform the folding operation.

34. The method (100c) as claimed in claims 29, 30 & 31, wherein the first folding machine (210c) is a knife folding machine, the second folding machine (220c) is a knife folding machine, the third folding machine (230c) is a knife folding machine, the fourth folding machine (240c) is a knife folding machine, and the fifth folding machine (250c) is a knife folding machine.

35. The method (100c) as claimed in claims in claims 29, 30 & 31, wherein fold lines of the first cross fold, the second cross fold, the third cross fold, the fourth cross fold and the fifth cross fold are perpendicular to the length of the strip (500c).

36. The method (100c) as claimed in claims 29, 30 & 31, wherein the seventh folded segment (542c) and the eighth folded segment (544c) are binds by a binding agent applied accordingly thereon, the binding agent is an adhesive or the seventh folded segment (542b), and the eighth folded segment (544c) are bind by a binding member, the binding member is a clip or adhesive tape.

37. The method (100c) as claimed in claims 29, 30 & 31, wherein the third folded strip (530c) is pressed by a first pressing unit (310c) before feeding to the fifth folding machine (250a), the informational item (540c) is pressed by a second pressing unit (320c) before moving the informational item (540c) to a predefined destination.

38. A machinery (200c) for making an informational item (540c), the informational item (540c) is having product information printed thereon, the machinery (200c) comprises:
a first folding machine (210c) adapted to receive a sheet (480c) thereto, the first folding machine (210c) makes at least two parallel folds on the received sheet (480c) for making a strip (500c), the first folding machine (210c) is adapted to virtually dividing the strip (500c) into equal segments by marking fold lines thereon;
a second folding machine (220c) adapted to receive the strip (500c) thereto, the second folding machine (220c) makes a first cross fold on the strip (500c) for making a first folded strip (510c), the first folded strip (510c) is having a first folded segment (512c) and a second folded segment (514c), wherein the length of the first folded segment (512c) is unequal to the length of the second folded segment (514c), the first folded segment (512c) and the second folded segment (514c) are having predefined lengths;
a third folding machine (230c) adapted to receive the first folded strip (510c) thereto, the third folding machine (230c) makes a second cross fold on the first folded strip (510c) for making a second folded strip (520c), the second folded strip (520c) is having a third folded segment (522c), and a fourth folded segment (524c), the third folded segment (522c) and the fourth folded segment (524c) are having predefined lengths;
a fourth folding machine (240c) adapted to receive the second folded strip (520c) thereto, the fourth folding machine(240c) makes a third cross fold on the second folded strip (520c) for making a third folded strip (530c), the third folded strip (530c) is having a fifth folded segment (532c) and a sixth folded segment (534c); and
a fifth folding machine (250c) adapted to receive the third folded strip (530c) thereto, the fifth folding machine (250c) makes a fourth cross fold on the third folded strip (530c) for making the informational item (540c), the informational item (540c) is having a seventh folded segment (542c) and an eighth folded segment (544c).

39. A machinery (200c) for making an informational item (540c), the informational item (540c) is having product information printed thereon, the machinery (200c) comprises:
a first folding machine (210c) adapted to receive a sheet (480c) thereto, the first folding machine (210c) makes at least two parallel folds on the received sheet (480c) for making a strip (500c), the first folding machine (210c) virtually divides the strip (500c) into equal segments by marking fold lines thereon, the length of each segment is equal to a length (L) of the informational item (540c);
a second folding machine (220c) adapted to receive the strip (500c) thereto, the second folding machine (220c) makes a first cross fold on the strip (500c) for making a first folded strip (510c), the first folded strip (510c) is having a first folded segment (512c) and a second folded segment (514c), wherein the length of the first folded segment (512c) is unequal to the length of the second folded segment (514c), the first folded segment (512c) and the second folded segment (514c) are having predefined lengths, the predefined length of the first folded segment (512c) or/and the second folded segment (514c) is equal to decimal multiples of the segment;
a third folding machine (230c) adapted to receive the first folded strip (510c) thereto, the third folding machine (230c) makes a second cross fold on the first folded strip (510c) for making a second folded strip (520c), the second folded strip (520c) is having a third folded segment (522c) and a fourth folded segment (524c), the third folded segment (522c) and the fourth folded segment (524c) are having predefined lengths, either the length of the third folded segment (522c) or/and the fourth folded segment (524c) is equal to the decimal multiples of the segment;
a fourth folding machine (240c) adapted to receive the second folded strip (520c) thereto, the fourth folding machine(240c) makes a third cross fold on the second folded strip (520c) for making a third folded strip (530c), the third folded strip (530c) is having a fifth folded segment (532c) and a sixth folded segment (534c); and
a fifth folding machine (250c) adapted to receive the third folded strip (530c) thereto, the fifth folding machine (250c) makes a fourth cross fold on the third folded strip (530c) for making the informational item (540c), the informational item (540c) is having a seventh folded segment (542c) and an eighth folded segment (544c).

40. A machinery (200c) for making an informational item (540c), the informational item (540c) is having product information printed thereon, the machinery (200c) comprises:
a first folding machine (210c) adapted to receive a sheet (480c) thereto, the first folding machine (210c) makes at least two parallel folds on the received sheet (480c) for making a strip (500c), the first folding machine (210c) virtually divides the strip (500c) into ten equal segments by marking fold lines thereon, the length of each segment is equal to a length (L) of the informational item (540c);
a second folding machine (220c) adapted to receive the strip (500c) thereto, the second folding machine (220c) makes a first cross fold on the strip (500c) for making a first folded strip (510c), the first folded strip (510c) is having a first folded segment (512c) and a second folded segment (514c), the length of the first folded segment (512c) is equal to the five and three tenths or four and seven-tenths equal segments (L) and the length of the second folded segment (514c) is equal to four and seven-tenths or five and three tenths equal segments;
a third folding machine (230c) adapted to receive the first folded strip (510c) thereto, the third folding machine (230c) makes a second cross fold on the first folded strip (510c) for making a second folded strip (520c), the second folded strip (520c) is having a third folded segment (522c) and a fourth folded segment (524c), the length of the third folded segment (522c) is equal to two and three tenths equal segments, and the length of the fourth folded segment (524c) is equal to three equal segments;
a fourth folding machine (240c) adapted to receive the second folded strip (520c) thereto, the fourth folding machine(240c) makes a third cross fold on the second folded strip (520c) for making a third folded strip (530c), the third folded strip (530c) is having a fifth folded segment (532c) and a sixth folded segment (534c); and
a fifth folding machine (250c) adapted to receive the third folded strip (530c) thereto, the fifth folding machine (250c) makes a fourth cross fold on the third folded strip (530c) for making the informational item (540c), the informational item (540c) is having a seventh folded segment (542c) and an eighth folded segment (544c).

41. The machinery (200c) as claimed in claims 38, 39 & 40, wherein the first folding machine (210c) is a roller folding machine, the second folding machine (220c) is a roller folding machine, the third folding machine (230c) is a roller folding machine, the fourth folding machine (240c) is a roller folding machine, and the fifth folding machine (250c) is a roller folding machine, the roller folding machine includes a plurality of rollers, the plurality of rollers is operated perform the folding operation.

42. The machinery (200c) as claimed in claims 38, 39 & 40, wherein the first folding machine (210c) is a knife folding machine, the second folding machine (220c) is a knife folding machine, the third folding machine (230c) is a knife folding machine, the fourth folding machine (240c) is a knife folding machine, the fifth folding machine (250c) is a knife folding machine, the knife folding machine includes a knife, the knife is operated perform a folding operation.

43. The machinery (200c) as claimed in claims 38, 39 & 40, wherein the machinery (200c) includes an adhesive application unit, the adhesive application unit is operated to apply a binding agent on the seventh folded segment (542c), and the eighth folded segment (544c) and the binding agent applied seventh folded segment (542c), and the eighth folded segment (544c) are pressed accordingly for binding there together, and the binding agent is an adhesive.

44. The machinery (200c) as claimed in claim claims 38, 39 & 40, wherein the second folding machine (220c) and the third folding machine (230c) are integrally mounted in a housing (300c).

45. The machinery (200c) as claimed in claim claims 38, 39 & 40, wherein fold lines of the first cross fold, the second cross fold, the third cross fold, the fourth cross fold and the fifth cross fold are perpendicular to the length of the strip (500c).

46. The machinery (200c) as claimed in claim claims 38, 39 & 40, wherein the first folding machine (210c) includes a fold line marking unit (212c) for marking at least one virtual mark or on the strip (500c), the fold line marking unit (212c) includes mechanical elements such as rollers (216c), sprinklers (214c) or markers and the like arranged accordingly to mark the at least one virtual mark or groove for dividing the strip (500c) into a first folded segment (512c) and a second folded segment (514c), wherein the length of the first folded segment (512c) is more than the length of the second folded segment (514c), wherein sprinklers (214c) are arranged accordingly to sprinkle water along the at least one virtual mark on the sheet (480c) before feeding to the rollers of the first folding machine (210c) and rollers (216c) are arranged accordingly to make the groove along at least one mark on the strip (500c).

47. The machinery (200c) as claimed in claim claims 38, 39 & 40, wherein the first folding machine (210c) includes a fold line marking unit (212c) for marking at least one virtual mark or on the strip (500c), the fold line marking unit (212c) includes mechanical elements such as rollers (216c), sprinklers (214c) or markers and the like arranged accordingly to mark the at least one virtual mark or groove for dividing the strip (500c) into a first folded segment (512c) and a second folded segment (514c), wherein the length of the first folded segment (512c) is less than the length of the second folded segment (514c), wherein sprinklers (214c) are arranged accordingly to sprinkle water along the at least one virtual mark on the sheet (480c) before feeding to the rollers of the first folding machine (210c) and rollers (216c) are arranged accordingly to make the groove along at least one mark on the strip (500c).

48. The machinery (200c) as claimed in claim claims 38, 39 & 40, wherein the machinery (200c) includes a first pressing unit (310c) for pressing the third folded strip (530c) before feeding to the fifth folding machine (250c), a second pressing unit (320c) for pressing the informational item (540c) before sending to a predefined destination.

49. The machinery (200c) as claimed in claim claims 38, 39 & 40, wherein the machinery (200c) includes a conveyor system (501c), the conveyor system (501c) is operated to transfer the sheet (480c) to the first folding machine (210c), and transfer the strip (500c) to the second folding machine (220c), transfer the first folded strip (510c) to the third folding machine (230c), transfer the second folded strip (520c) to the fourth folding machine (240c), transfer the third folded strip (530c) to the fifth folding machine (250c), transfer the informational item (540) to a predefined destination.

50. The machinery (200c) as claimed in claims 38, 39, 40 & 48, wherein the machinery (200c) includes a conveyor system (501c), the conveyor system (501c) is operated to transfer the sheet (480c) to the first folding machine (210c), and transfer the strip (500c) to the second folding machine (220c), transfer the first folded strip (510c) to the third folding machine (230c), transfer the second folded strip (520c) to the fourth folding machine (240c), transfer the third folded strip (530c) from the first pressing unit (310c) to the fifth folding machine (250c) and transfer the informational item (540) from the second pressing unit (320c) to a predefined destination.

51. The machinery (200c) as claimed in claims 49&50, wherein the conveyor system (501c) includes a conveyor path (502c) having at least one segment, the segments of the conveyor path (502c) is (are) arranged according to the available space for arranging (set up) the machinery to configure the conveyor path.

52. The machinery (200c) as claimed in claim 51, wherein the shape of the conveyor path (502c) is “L”, “U”, “C” & “Z”.

53. The machinery (200c) as claimed in claim 49&50, wherein the conveyor system (501c) is a belt conveyor system or a chain conveyor system or air conveyor system.
